(19) United States
(12) Patent Application Publication
(10) Pub. No.: US 2014/0210942 A1
(43) Pub. Date: Jul. 31, 2014

(54) FAST PROCESSING OF INFORMATION REPRESENTED IN DIGITAL HOLOGRAMS

(71) Applicant: City University of Hong Kong, Kowloon (HK)

(72) Inventor: Peter Wai Ming Tsang, Kowloon (HK)

(73) Assignee: City University of Hong Kong, Kowloon (HK)

(21) Appl. No.: 14/061,262

(22) Filed: Oct. 23, 2013

Related U.S. Application Data
(60) Provisional application No. 61/759,256, filed on Jan. 31, 2013.

(51) Int. Cl. G03H 1/04

(52) U.S. Cl. CPC G03H 1/0443
USPC 348/40

(57) ABSTRACT

Techniques for fast processing of information represented in digital holograms to facilitate generating and displaying 3-D holographic images representative of a 3-D object scene are presented. A holographic generator component (HGC) can receive or generate information representing a 3-D object scene. In real or near real time, the HGC can back-project a hologram to a virtual 2-D image known as a virtual diffraction plane (VDP); process the VDP to enhance optical properties of the VDP to facilitate enhancing or adjusting the optical properties of the 3-D holographic images when displayed by a display component; and expand the VDP to facilitate generating 3-D holographic images that can represent or recreate the 3-D object scene. The HGC can thereby process digital 3-D holograms of moderate size and display 3-D holographic images generated from the processed 3-D holograms at a desirably fast video rate.

### CROSS-REFERENCE TO RELATED APPLICATIONS

This application claims priority to U.S. Provisional Application No. 61/759,256, filed Jan. 31, 2013, and entitled “Fast Processing of Information Represented in Digital Holograms”, the entirety of which is incorporated herein by reference.

### TECHNICAL FIELD

The subject disclosure relates generally to holograms, and in particular, to fast processing of information represented in digital holograms.

### BACKGROUND

With the advancement of computers, digital holography has become an area of interest and has gained some popularity. Research findings derived from this technology can enable digital holograms to be captured optically or generated numerically, and to be displayed with holographic display devices such as a liquid crystal on silicon (LCOS) display device. Holograms generated in this manner can be in the form of numerical data that can be recorded, transmitted, and processed using digital techniques. On top of that, the availability of high capacity digital storage and wide-band communication technologies also lead to the emergence of real-time video holography, casting light on the future of a 3-D television system.

The above-described description is merely intended to provide a contextual overview of generating and displaying digital holograms, and is not intended to be exhaustive.

### SUMMARY

The following presents a simplified summary of various aspects of the disclosed subject matter in order to provide a basic understanding of some aspects described herein. This summary is not an extensive overview of the disclosed subject matter. It is intended to neither identify key or critical elements of the disclosed subject matter nor delineate the scope of such aspects. Its sole purpose is to present some concepts of the disclosed subject matter in a simplified form as a prelude to the more detailed description that is presented later.

Systems, methods, computer readable storage mediums, and techniques disclosed herein relate to processing and generating holograms. Disclosed herein is a system comprising at least one memory that stores computer executable components, and at least one processor that facilitates execution of the computer executable components stored in the at least one memory. The computer executable components comprising a hologram enhancer component that projects a hologram on a virtual diffraction plane that is within a defined distance of an object space associated with an object scene represented by the hologram, processes one or more optical properties of one or more respective regions on the virtual diffraction plane to facilitate modification of the one or more optical characteristics of the one or more respective regions on the virtual diffraction plane to generate a processed virtual diffraction plane that facilitates generation of a processed hologram that represents the object scene. The computer executable components also including a display component that presents one or more holographic images associated with the processed hologram.

Also disclosed herein is a method that includes projecting, by a system comprising a processor, a hologram on a virtual diffraction plane that is within a defined distance of an object space associated with an object scene represented by the hologram. The method also includes processing, by the system, one or more optical properties of one or more respective regions on the virtual diffraction plane to facilitate modifying one or more optical characteristics of the one or more respective regions on the virtual diffraction plane to facilitate generating a processed virtual diffraction plane that facilitates generating a processed hologram that represents the object scene.

Further disclosed herein is a computer readable storage medium comprising computer executable instructions that, in response to execution, cause a system including a processor to perform operations. The operations include projecting a hologram on a virtual diffraction plane that is within a defined distance of an object space associated with an object scene represented by the hologram. The operations also include modifying one or more optical properties of one or more respective regions on the virtual diffraction plane to facilitate modifying one or more optical characteristics of the one or more respective regions on the virtual diffraction plane to facilitate generating a processed virtual diffraction plane that facilitates generating a processed hologram that represents the object scene.

The disclosed subject matter also includes a system comprising means for projecting a hologram on a virtual diffraction plane that is within a defined distance of an object space associated with an object scene represented by the hologram. The system also includes means for adjusting one or more optical properties of one or more respective regions on the virtual diffraction plane to facilitate adjusting one or more optical characteristics of the one or more respective regions on the virtual diffraction plane to facilitate generating a processed virtual diffraction plane that facilitates generating a processed hologram that represents the object scene.

The following description and the annexed drawings set forth in detail certain illustrative aspects of the disclosed subject matter. These aspects are indicative, however, of but a few of the various ways in which the principles of the disclosed subject matter may be employed, and the disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can efficiently and quickly (e.g., in real time or at least near real time) generate a three-dimensional (3-D) hologram(s) (e.g., full-parallax 3-D Fresnel hologram(s)) of a 3-D object scene(s) in accordance with various aspects and embodiments of the disclosed subject matter.

FIG. 2 depicts a diagram of an example image that can illustrate a spatial relation between a 3-D object space associated with the 3-D object scene, a two-dimensional (2-D) virtual diffraction plane (VDP), and a hologram that can represent the 3-D object scene, in accordance with various aspects and embodiments of the disclosed subject matter.

FIG. 3A illustrates a double-depth image that is used to facilitate evaluating the performance of techniques of the disclosed subject matter, wherein the image is partitioned into a left side and a right side.

FIGS. 3B and 3C depict example numerical reconstructed holographic images at the two depth planes.

FIGS. 3D and 3E illustrate example reconstructed holographic images at the two depth planes when conventional histogram equalization is directly applied to the hologram.

FIGS. 4A and 4B depict example reconstructed holographic images at the two depth values produced from a hologram representing the double-depth image of FIG. 3A, wherein the hologram has been enhanced using a VDP (e.g., with its optical properties enhanced), in accordance with various aspects and embodiments of the disclosed subject matter.

FIG. 5A illustrates an example image of a hemisphere with the texture of an Earth image that has a radius of 0.5 millimeters (mm) with its tip located at 0.3 m from a hologram.

FIG. 5B depicts an example reconstructed holographic image (e.g., numerical reconstructed image) produced from the hologram of the hemisphere with the texture of the Earth image positioned at 0.3 m from the hologram plane, wherein the hologram has been subject to high pass filtering on the left half plane.

FIG. 5C illustrates an example reconstructed holographic image (e.g., numerical reconstructed image) produced from the hologram of the hemisphere with the texture of the Earth image positioned at 0.3 m from the hologram plane, wherein the VDP of the hologram has been subject to high pass filtering on the left half plane, in accordance with various aspects and embodiments of the disclosed subject matter.

FIG. 6 illustrates a diagram of an example image that can depict a spatial relation between an object point of a 3-D object scene, a hypothetical or virtual wavefront recording plane (WRP), and a hologram that can represent the 3-D object scene, in connection with employing a relighting technique to facilitate relighting the hologram, in accordance with various aspects and embodiments of the disclosed subject matter.

FIG. 7 illustrates an example relighting image that can be employed to facilitate relighting all or a portion of a hologram, in accordance with various aspects and embodiments of the disclosed subject matter.

FIG. 8A presents an example scene image that is a double-depth scene image that is partitioned into left and right sections positioned at 0.58 m and 0.6 m from the hologram plane, respectively.

FIG. 8B depicts an example relighting image that is employed to simulate the directional illumination emerging from an upper right corner of an image.

FIGS. 8C and 8D present numerical reconstructed images representing the scene image at the two depth planes when relighting is not applied.

FIGS. 9A and 9B present numerical reconstructed images of the hologram at the two depth planes, wherein the hologram has been direct relit with the relighting image depicted in FIG. 8B.

FIGS. 10A and 10B respectively present reconstructed images of relighted holograms at the two depth planes, in accordance with aspects and embodiments of the disclosed subject matter.

FIGS. 11A, 11B, and 11C present respective images that can further illustrate a relighting process that can relight a digital hologram via use of a WRP, in accordance with various aspects and embodiments of the disclosed subject matter.

FIG. 12 illustrates a block diagram of an example holographic generator component (HGC) that can efficiently generate (e.g., in real or at least near real time) a 3-D hologram(s) (e.g., a modified or an enhanced 3-D Fresnel hologram(s)) of a real or synthetic 3-D object scene(s), in accordance with various aspects and implementations of the disclosed subject matter.

FIG. 13 depicts a block diagram of a system that can employ intelligence to facilitate generation of a 3-D hologram (e.g., a modified or an enhanced full-parallax 3-D Fresnel hologram) of a real or synthetic 3-D object scene in accordance with an embodiment of the disclosed subject matter.

FIG. 14 a flow diagram of an example method for enhancing and generating (e.g., enhancing and generating in real or at least near real time) a 3-D hologram (e.g., an enhanced full-parallax 3-D Fresnel hologram of a real or synthetic 3-D object scene), in accordance with various embodiments and aspects of the disclosed subject matter.

FIG. 15 depicts a flow diagram of an example method that can apply a sharpening filter(s) or histogram equalization to a VDP associated with a hologram to efficiently generate (e.g., in real or at least near real time) a modified (e.g., an enhanced) hologram (e.g., an enhanced full-parallax 3-D Fresnel hologram of a real or synthetic 3-D object scene), in accordance with various embodiments and aspects of the disclosed subject matter.

FIG. 16 presents a flow diagram of an example method for relighting a hologram to facilitate generating (e.g., in real or at least near real time) an enhanced (e.g., desirably relit) hologram (e.g., an enhanced full-parallax 3-D Fresnel hologram) of a real or synthetic 3-D object scene), in accordance with various embodiments and aspects of the disclosed subject matter.

FIG. 17 is a schematic block diagram illustrating a suitable operating environment.

FIG. 18 is a schematic block diagram of a sample-computing environment.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

With the advancement of computers, digital holography has become an area of interest and has gained some popularity. Research findings derived from this technology can enable digital holograms to be captured optically or generated numerically, and to be displayed with holographic display devices such as a liquid crystal on silicon (LCOS) display device. Holograms generated in this manner can be in the form of numerical data that can be recorded, transmitted, and processed using digital techniques. On top of that, the availability of high capacity digital storage and wide-band communication technologies also lead to the emergence of real-time video holography, casting light on the future of a three-dimensional (3-D) television system.

Despite the advancement on digital holography, there is a general lack of processing techniques that are sufficiently fast enough to enable the pictorial contents of a digital hologram to be processed and enhanced (e.g., in real or at least near real time). Traditional methods that can be employed for processing optical images, such as those captured with a digital camera, generally may not be applicable to holograms as, in contrast to images captured with a digital camera, each pixel in the hologram can be representing holistic information, rather than localized information. Ideally, one could reconstruct, process, and re-generate a digital hologram that can represent 3-D scene information. However, such reconstruction method can be unavailable and the re-generation of a hologram from the processed 3-D data can be complicated and time consuming.

To that end, techniques for fast (e.g., in real-time or at least near real-time) processing of information represented in digital holograms to facilitate generating and displaying 3-D holograms (e.g., full-parallax 3-D Fresnel holograms) of a real or synthetic 3-D object scene (e.g., in real-time or at least near real-time) are presented. A holographic generator component (HGC) can receive (e.g., obtain, capture, etc.) a real 3-D object scene (e.g., a captured scene), or can generate or receive a synthetic 3-D object scene. The HGC can generate model data that can represent the 3-D object scene from a desired number of viewing perspectives. The HGC also can convert the model data to generate digital holographic data for the 3-D hologram that can be used to facilitate generating and displaying 3-D holographic images that can represent or recreate the 3-D object scene.

To facilitate quickly processing information represented in digital holograms to facilitate generating and displaying 3-D holographic images that can represent the 3-D object scene, the HGC can back-project the hologram to a virtual or hypothetical two-dimensional (2-D) image known as a virtual diffraction plane (VDP). The HGC can process the VDP (e.g., enhance or adjust brightness and/or contrast, enhance or adjust sharpness, etc., all or a portion (e.g., region(s), pixel(s)) of the VDP) to enhance or adjust (e.g., enhance or adjust (e.g., change, modify) in real-time or at least near real-time) optical properties of the VDP to facilitate enhancing or adjusting the optical properties of the 3-D holographic images when displayed by a display component (e.g., LCOS display device). The HGC also can expand the VDP to facilitate generating a digital hologram (e.g., 3-D holographic images) that can represent or recreate the 3-D object scene. By employing these and other techniques, the HGC can process digital 3-D holograms of moderate size (e.g., 2048×2048 pixels) and display 3-D holographic images generated from the processed 3-D holograms at a standard or other desired video rate (e.g., a video rate of up to approximately 100 frames per second).

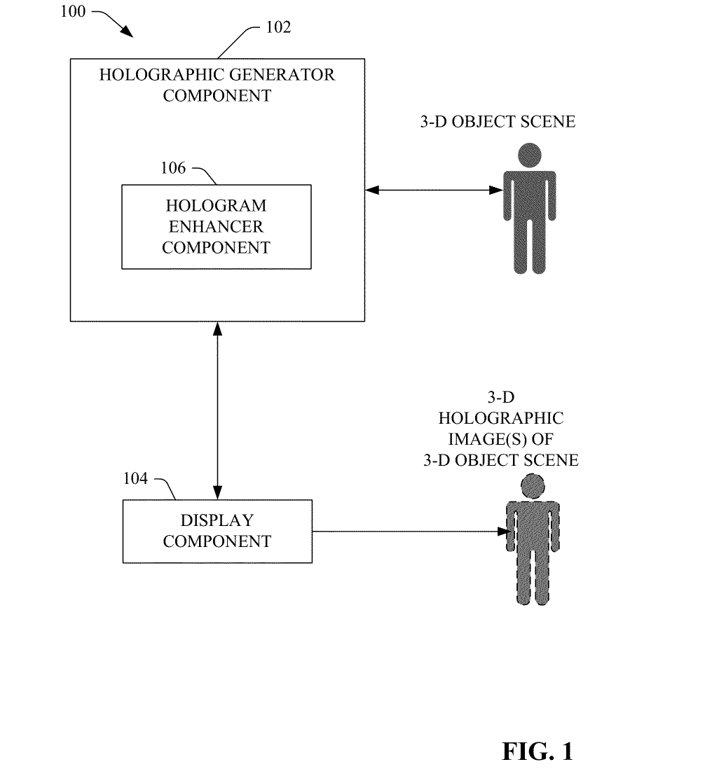

Turning to FIG. 1, illustrated is a block diagram of an example system 100 that can efficiently and quickly (e.g., in real time or at least near real time) generate a three-dimensional (3-D) hologram(s) (e.g., full-parallax 3-D Fresnel hologram(s)) of a real or synthetic 3-D object scene(s) in accordance with various aspects and embodiments of the disclosed subject matter. In an aspect, the system 100 can include a holographic generator component (HGC) 102 that can desirably generate a hologram (e.g., a hologram of a sequence of 3-D holographic images) that can represent a 3-D object scene (e.g., real or computer-synthesized 3-D object scene) from multiple different viewing perspectives that can correspond to multiple different viewing perspectives of the original 3-D object scene. The hologram can be used to generate, reconstruct, or reproduce 3-D holographic images for display to one or more viewers, wherein the 3-D holographic images can represent or recreate the original 3-D object scene from multiple visual perspectives. For example, the HGC 102 can generate a 3-D hologram (and corresponding 3-D holographic images) that can be a full-parallax 3-D Fresnel hologram that can include (e.g., can have preserved) parallax information (e.g., horizontal and vertical parallax information) and depth information (e.g., depth perception information) associated with the original 3-D object scene, in accordance with various aspects and embodiments of the disclosed subject matter, as more fully disclosed herein

In some embodiments, the HGC 102 and/or other components (e.g., display component 104) of the system 100 can be part of a multiple-view aerial holographic projection system (MVAHPS) that can generate and display a 3-D holographic image(s) of a 3-D real or synthetic, static or animated, object scene viewable from multiple perspectives (e.g., multiple angles in relation to the 3-D object scene), wherein the 3-D holographic image can be viewed, for example, as a 3-D image floating in mid-air in a desired display area (e.g., 3-D chamber). The HGC 102 and display component 104 (e.g., LCOS display device) can facilitate generating and displaying holograms at video rate in real time or near real time (e.g., facilitate generating and displaying, for example, a 2048×2048 pixel hologram, which can represent 4 million object points, at up to approximately 100 frames per second in real time or near real time).

The HGC 102 can receive (e.g., obtain) a real 3-D object scene (e.g., captured 3-D object scene), or can generate or receive a synthetic 3-D object scene (e.g., computer generated 3-D object scene). In some implementations, the HGC 102 can generate or receive a computer generated 3-D object scene that can be realized (e.g., generated) using numerical means without the presence of a physical or real-world 3-D object scene. Based at least in part on the real or synthetic 3-D object scene, the HGC 102 can generate holograms, wherein the generated holograms (e.g., full-parallax 3-D Fresnel holographic images) can represent or recreate the original 3-D object scene from multiple visual perspectives (e.g., multiple viewing angles).

In some implementations, the HGC 102 can generate model data that can represent the 3-D object scene from a desired number of viewing perspectives, based at least in part on received or generated information regarding the original 3-D object scene from multiple visual perspectives. The HGC 102 also can convert the model data to generate digital holographic data for the 3-D hologram that can be used to facilitate generating and displaying 3-D holographic images that can represent or recreate the original 3-D object scene from multiple visual perspectives.

In a digital hologram, a complex on-axis hologram H(x,y) can record the object waves that are emitted from the object points in a 3-D object scene. Suppose the 3-D object scene is a 3-D surface with the intensity of each object point, and its perpendicular distance from the hologram given by I(x,y) and d(x,y), respectively, H(x,y) can be mathematically described by Equation (1):

$$H ( x , y ) = {{\sum }_{m = 1}}^{X - 1} {\sum }_{n = 1}^{Y - 1} \frac{I ( m , n )}{r ( m , n , x , y )} exp [ j \frac{2 π}{λ} r ( m , n , x , y ) ] , \qquad ( 1 )$$

In Equation (1), X and Y are the horizontal and vertical extents of the hologram, respectively, and are assumed to be identical to that of the object scene; λ, is the wavelength of the optical beam which is used to generate the complex hologram; the term r(m,n,x,y) is the distance of an object point at position (m,n) to a point at (x,y) on the hologram. A digital hologram can be generated numerically based on Equation (1), or acquired optically using optical means. However, it sometimes can be difficult to control the illumination in the process of capturing the 3-D object scene, or to control the nature of the 3-D object scene, to attain the desired optical properties (e.g., sharpness, brightness, contrast, etc.). This can result in blurriness, overexposure, or underexposure in the reconstructed image representing the original scene.

In traditional photography, these types of defects can be easily compensated by re-adjusting the intensity of individual pixels in the reconstructed image. However, it can be seen or inferred from Equation (1) that such an approach of re-adjusting the intensity of individual pixels cannot be applied directly to a digital hologram as each pixel in the digital hologram is representing holistic information rather than local information. As a result, modifying a single hologram pixel can lead to a change in the entire scene, instead of localizing in the area around the pixel being modified. Conceptually, it is possible to reconstruct the original 3-D scene, apply some sort of enhancement to correct the optical properties, and convert the result back to a hologram. However, such an inverse process has been shown to be both complicated and computationally intensive. Until now, only the recovery of simple image scenes have been demonstrated by the existing techniques. Besides, even if the original scene is available or can be reconstructed, the generation of the hologram with the existing techniques can be undesirably time-consuming.

The disclosed subject matter can overcome the deficiencies of conventional techniques and can quickly process information represented in digital holograms to facilitate generating and displaying 3-D holographic images that can represent the 3-D object scene. To facilitate quickly processing information represented in digital holograms, the HGC 102 can include a hologram enhancer component 106 that can quickly (e.g., in real-time or at least near real-time) process information represented in digital holograms to facilitate generating and displaying 3-D holograms (e.g., full-parallax 3-D Fresnel holograms) of the original 3-D object scene. The HGC 102, by employing the hologram enhancer component 106, can utilize techniques that can facilitate quickly and directly processing the optical properties of images recorded in a digital hologram, without the need of regenerating the digital hologram from the original object scene.

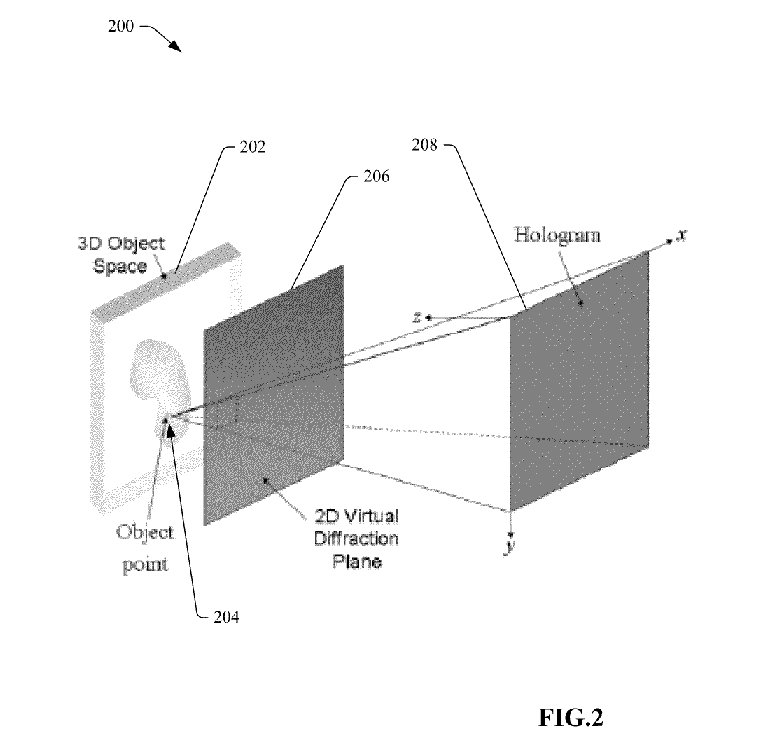

Referring to FIG. 2 (along with FIG. 1), FIG. 2 depicts a diagram of an example image 200 that can illustrate a spatial relation between a 3-D object space associated with the 3-D object scene, a 2-D virtual diffraction plane (VDP), and a hologram that can represent the 3-D object scene, in accordance with various aspects and embodiments of the disclosed subject matter. The example illustration 200 can include the 3-D object space 202 that can comprise a plurality of object points, including object point 204, that can be representative of the original 3-D object scene. The example illustration 200 also can include the 2-D VDP 206 and the 3-D hologram 208 that can be representative of the original 3-D object scene.

The VDP 206 can be located in close proximity to the original 3-D object (e.g., represented in the 3-D object space 202). From the example image 200, it can be seen that the object beam emerging from the object point 204 on the 3-D object space 202 will only cover a relatively small region 210, which can be referred to as the support 210 (e.g., shown marked in dotted lines in FIG. 2), on the VDP 206. It also can be inferred that the closer the distance between the object point 204 and the VDP 206, the smaller in size the support 210 of the diffraction pattern will be. For a 3-D object scene composing of multiple object points, each object point can contribute to the VDP 206 in a similar manner (e.g., each object point of the 3-D object space 202 can be associated with a corresponding support on the VDP 206). As such, the VDP 206 can be a complex image which can contain the amplitude and phase information of the 3-D hologram 208, as well as similar optical properties of the 3-D object space 202. For instance, the VDP 206 can be interpreted as a portal between the digital 3-D hologram 208 and the 3-D object space 202 that can carry respective information of both of those entities.

The hologram enhancer component 106 can derive, determine, or generate the VDP 306 based at least in part on the information (e.g., holographic data) associated with the 3-D hologram 208 and/or the corresponding 3-D object space 202. For instance, the hologram enhancer component 106 can derive the field distribution on the VDP 206 that can correspond to the hologram 208. The hologram enhancer component 106 can back-project the hologram (e.g., holographic data of the hologram) to a virtual 2-D plane, for example, by back-projecting the hologram to a virtual or hypothetical 2-D image known as a VDP 206, which can located near to the 3-D object space 202, as more fully disclosed herein. For instance, the hologram enhancer component 106 can back-project the hologram 208 to the VDP 206, wherein the VDP 206 can be located such that it can be represented as being in relatively close proximity to the original 3-D object scene. With the VDP 206 at relatively close proximity to the 3-D object space 202, the magnitude of the field distribution on the VDP 206 can be a de-focused version of the original 3-D scene, with both sharing similar optical properties. As such, local modification of the optical properties on the VDP 206 can invoke, to a desirably good approximation, similar changes on the optical properties of the 3-D object scene the VDP 206 represents.

In some implementations, the hologram enhancer component 106 can determine, derive, or generate the VDP 206, in accordance with Equations (2) and (3). The VDP 206 and the 3-D hologram 208 can be assumed to have identical horizontal and vertical extents of X and Y units, respectively. If the VDP 206 is located at an axial distance z_{w} from the 3-D hologram 208, and denoted by the complex wavefront u_{w}(x,y), the VDP 206 can be determined or derived, using Equation (2), as

u_{w}(x,y)=H(x,y)*g(x,y), (2)

where

$$g ( x , y ) = \frac{- j}{λ {z}_{w}} exp ( j 2 π {z}_{w} / λ ) exp ( - j \frac{π}{λ {z}_{w}} ( {x}^{2} + {y}^{2} ) )$$

is the complex conjugate of the free-space spatial impulse response in Fourier optics, and * denotes a convolution operation. Denoting f[{sub-equation}] and F⁻¹[{sub-equation}] to be the forward and inverse fast Fourier transform (FFT) operation performed on the sub-equation or mathematical elements therein, respectively, the convolution process in Equation (2) can be expressed in the frequency domain, using Equation (3), as follows:

u_{w}(x,y)=F⁻¹[F[H(x,y)]·F[g(x,y)]]. (3)

The hologram enhancer component 106 also can process the VDP 206 associated with the original 3-D object scene to enhance or adjust optical properties of the VDP 206 to facilitate enhancing or adjusting the optical properties of the 3-D holographic images of the hologram 308 that can be generated based at least in part on the processed VDP 206 when the 3-D holographic images are displayed by the display component 104 (e.g., LCOS display device). For instance, the hologram enhancer component 106 can process the VDP 206 to enhance or adjust sharpness of at least a portion of the VDP 206, enhance or adjust brightness and/or contrast of at least a portion of the VDP 206, and/or enhance or adjust other optical characteristics on at least a portion (e.g., region(s), pixel(s), etc.) of the VDP 206, etc., to facilitate enhancing or adjusting (e.g., enhancing or adjusting (e.g., changing, modifying) in real-time or at least near real-time) the optical properties of the VDP 206 to facilitate enhancing or adjusting the optical properties of the 3-D holographic images of the hologram 308 when the 3-D holographic images are displayed by the display component 104.

To facilitate sharpening an image, or portion thereof, the hologram enhancer component 106 can apply a high-boost filter (e.g., a high-boost sharpening filter) to an area of interest R on the VDP 206 (e.g., apply a localized high-boost filter to a desired region on the VDP 206). For example, the hologram enhancer component 106 can apply a high-boost filter to an area of interest R on the VDP 206, using Equation (4), as follows:

u_{w}^{H}(x,y)|_{(x,y)εR}=A[u_{w}(x,y)−Bu_{w}^{L}(x,y)], (4)

wherein, in Equation (4), u_{w}^{L}(x, y) can be a low-pass version of R, where the value of each pixel at (x, y) can be derived from the mean of a 3×3 window centered at the corresponding pixel in u_{w}(x, y), using Equation (5), as follows:

$${u}_{w}^{L} ( x , y ) = \frac{1}{9} {\sum }_{m = - 1}^{1} {\sum }_{n = - 1}^{1} {u}_{w} ( x + m , y + n ) . \qquad ( 5 )$$

With further regard to Equation (4), the terms A and B can be constant values. The larger the values of A and B, the higher the brightness and sharpness of the region R, respectively, can be. In other implementations, the hologram enhancer component 106 can apply one or more other types of sharpening filters to the region R of the VDP 206 to facilitate sharpening the brightness and sharpness of the region R of the VDP 206.

The hologram enhancer component 106 also can apply histogram equalization to VDPs, like VDP 206, to facilitate adjusting the contrast or other optical properties of VDPs, wherein the histogram equalization process can be modified or tailored to enable histogram equalization to be applied to VDPs. For histogram equalization, the hologram enhancer component 106 can determine (e.g., calculate, compute) the histogram p(m) that can represent the probability density function of the magnitude of the pixel values in the VDP 206, which have been normalized to the range [0,1]. Supposing that there are M non-zero pixels in the VDP 206 and N(m) is the number of pixels with magnitude equals to m, the hologram enhancer component 106 can determine the histogram, for example, using Equation (6) as follows:

p(m)=N(m)/M. (6)

Note that, in the application of Equation (6), the pixels with zero value have been discarded. From Equation (6), the hologram enhancer component 106 can determine (e.g., calculate, compute) the cumulative distributive function (cdf(i)) associated with the VDP 206, for example, using Equation (7) as follows:

$$cdf ( i ) = {\sum }_{k = 0}^{i} p ( k ) . \qquad ( 7 )$$

Based at least in part on the cumulative distributive function, the hologram enhancer component 106 can determine or derive a mapping function to convert the magnitude of each pixel value (with original value ‘m’) for the VDP 206, or portion (e.g., region) thereof, to a new quantity ‘n’ between the interval (0,1). Suppose D is the maximum pixel value, the hologram enhancer component 106 can determine or derive the new magnitude quantity (e.g., value) ‘n’ of each pixel value of the VDP 206, or portion thereof, for example, using Equation (8) as follows:

n=D×cdf(m)|_{m>0}. (8)

From Equation (7), a re-scaling function can be obtained, for example, using Equation (9)

T(m)|_{m>0}=n/m. (9)

The hologram enhancer component 106 can apply the re-scaling function T(m) to re-scale the complex pixel values of the VDP 206, for example, using Equation (10) as follows:

v(x,y)=u_{w}(x,y)T(|u_{w}(x,y)|). (10)

The result from Equation (10) can be a processed VDP 206 that can have enhanced or modified optical properties as a result of the histogram equalization process applied to the VDP 206 by the hologram enhancer component 106.

The hologram enhancer component 106 also can generate an enhanced hologram from the processed VDP 206, wherein the optical properties of the enhanced hologram can be adjusted from that of the original hologram 208 based at least in part on the adjustments made to the optical properties of the corresponding VDP 206. For instance, the hologram enhancer component 106 can expand the processed VDP 206 to facilitate generating a digital 3-D hologram (e.g., 3-D holographic images) that can represent or recreate the 3-D object scene. As an example, the hologram enhancer component 106 can expand the processed (e.g., enhanced or modified) VDP 206 in part by diffracting the processed VDP 206 back to the original plane of the digital 3-D hologram 208 to facilitate generating a processed (e.g., enhanced or modified) digital 3-D hologram.

The hologram enhancer component 106 can expand the processed field distribution on the VDP 206, u_{ENC}(x, y), (e.g., which may have been sharpened, may have had its brightness adjusted, may have had its contrast adjusted, and/or may have been otherwise enhanced by applying a sharpening filter and/or histogram equalization, as disclosed herein), into a hologram (e.g., enhanced hologram), H_{ENC}(x, y), for example, using Equation (11) as follows:

H_{ENC}(x,y)=u_{ENC}(x,y)*g*(x,y). (11)

Hence, u_{ENC}(x, y)=v(x, y) or u_{ENC}(x, y)=u_{w}^{H}(x, y)|_{(x, y)εR} for highpass filtering and histogram equalization, respectively, in Equation (11) can be realized in the frequency domain by the hologram enhancer component 106, for example, using Equation (12) as follows:

H_{ENC}(x,y)=F⁻¹┐F[u_{ENC}(x,y)]·F[g*(x,y)]┌. (12)

The example techniques, algorithms, and/or equations for sharpening a VDP, applying histogram equalization to a VDP, and/or expanding a VDP (e.g., processed or enhanced VDP) to a hologram (e.g., processed or enhanced hologram) are non-limiting examples of various ways the aspects and embodiments of the disclosed subject matter can be implemented to facilitate modifying or enhancing holograms. It is to be appreciated and understood that a VDP can be sharpened, histogram equalization can be applied to a VDP, a VDP can be otherwise modified or enhanced (e.g., a VDP, such as a virtual wavefront recording plane (WRP), can be relit; other visual effects can be applied to a VDP; etc.), and/or a VDP (e.g., processed or enhanced VDP) can be expanded to a hologram (e.g., processed or enhanced hologram), etc., using other techniques, algorithms, and/or equations, in accordance with or based on the techniques or principles disclosed herein. For example, in addition to, or as an alternative to, applying a sharpening process, histogram equalization process, and/or relighting process to a VDP, the hologram enhancer component 106 can facilitate modifying or enhancing the VDP by applying low-pass filtering or another type of band-pass filtering, median filtering, noise filtering, spatial processing or filtering, intensity transformation, and/or another type(s)s of visual (e.g., image) processing or effects to the VDP using such other techniques, algorithms, and/or equations, to facilitate modifying or enhancing the visual quality and/or visual presentation of a hologram generated using the VDP (e.g., via expansion of the VDP to a hologram), in accordance with or based on the techniques or principles disclosed herein. Such other techniques, algorithms, and/or equations for processing VDPs or expanding VDPs to holograms are contemplated as being part of the disclosed subject matter.

From the disclosed subject matter, it can be seen that the hologram enhancement techniques employed by the hologram enhancer component 106 can involve a forward and an inverse FFT in both Equations (3) and (12). As the FFT of g (x, y) and g*(x, y) can be pre-computed in advance (e.g., by the hologram enhancer component 106 or another component), the computation loading of these two equations is mainly contributed by the four FFTs. The rest of the processes described in the disclosed subject matter can be relatively negligible in computation time. In some implementations, the hologram enhancer component 106 can use a graphic processing unit (GPU) to conduct the FFTs. As such, the HGC 102, using the hologram enhancer component 106 (e.g., employing a GPU), the enhancement of a digital hologram of size 2048×2048 pixels can be realized (e.g., processed and generated) in less than 10 milliseconds (ms), which is equivalent to a rate of over 100 frames per second. In addition to, or as an alternative to employing a GPU, in certain implementations, the hologram enhancer component 106 can employ and/or be associated with a field-programmable gate array (FPGA) that can be used to implement various aspects (e.g., derive or determine VDPs, computing FFTs, expanding VDPs into holograms, etc.) of the disclosed subject matter.

By employing these and other techniques, the HGC 102, including the hologram enhancer component 106, can process digital 3-D holograms of moderate size (e.g., 2048×2048 pixels) and facilitate displaying 3-D holographic images generated from the processed 3-D holograms at a standard or other desired video rate (e.g., a video rate of up to approximately 100 frames per second).

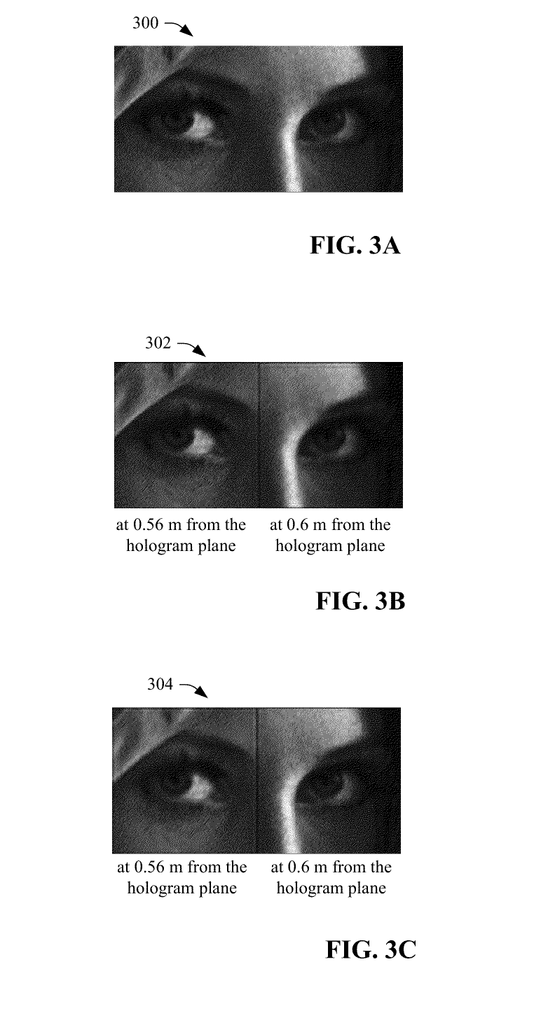

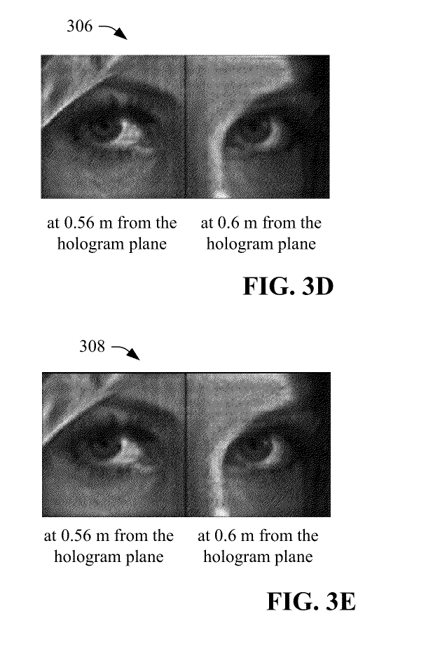

Referring briefly to FIGS. 3A through 3E, depicted are example images in connection with example experiments performed using various aspects of the disclosed subject matter. With regard to the example experimental results of the experiments, in FIG. 3A, depicted is a 1920×960 pixel double-depth image 300 that is used to facilitate evaluating the performance of techniques of the disclosed subject matter used for brightness and contrast enhancement of a hologram. The image 300 is evenly partitioned into a left side and a right side, located at 0.56 meters (m) and 0.6 m from the hologram, respectively. The image 300 is underexposed in most of the image area, but overexposed along the rim of the nose. The hologram enhancer component 106 applies Equation (2) to generate a 2048×2048 pixel digital hologram based on a wavelength of 650 nanometers (nm) and a hologram pixel size of 7 micrometers (um). FIGS. 3B and 3C depict example numerical reconstructed holographic images 302 and 304, respectively, at the two depth planes (e.g., representing the double-depth image 300 in FIG. 3A at 0.56 m and 0.6 m, respectively). When either side of the reconstructed image is in focus, it is a good recovery of the original content.

FIGS. 3D and 3E illustrate example reconstructed holographic images 306 and 308, respectively, at the two depth planes (at 0.56 m and 0.6 m, respectively) when conventional histogram equalization is directly applied to the hologram. In the example reconstructed holographic images 306 and 308, it can be seen that although the overall brightness is increased, the reconstructed images are heavily contaminated with noisy patterns. This is caused by the distortion on the entire hologram as the intensity of each pixel is modified after the conventional histogram equalization process is performed.

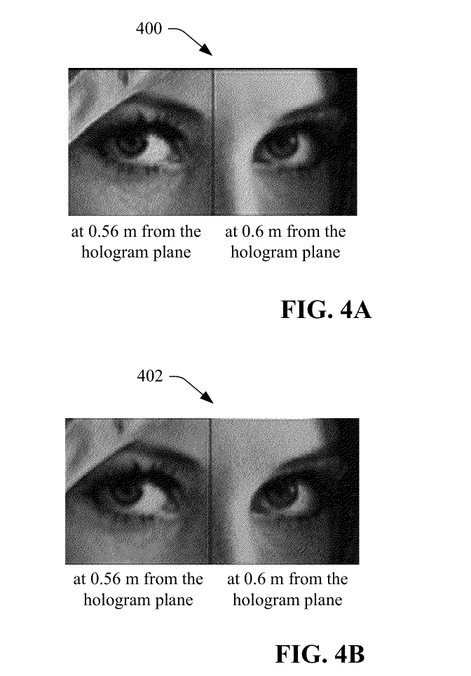

FIGS. 4A and 4B depict example reconstructed holographic images 400 and 402, respectively, at the two depth planes (at 0.56 m and 0.6 m, respectively) produced from a hologram representing the double-depth image 300 of FIG. 3A, wherein the hologram has been enhanced using a VDP (e.g., with its optical properties enhanced) positioned at 0.58 m, in accordance with various aspects and embodiments of the disclosed subject matter. The experimental results show, and as can be seen in FIGS. 4A and 4B, the reconstructed holographic images 400 and 402 each have improved brightness and contrast (e.g., as compared to the original image 300 in FIG. 3A), and the degradation shown in images 306 and 308 of FIGS. 3D and 3E is not present in the reconstructed holographic images 400 and 402.

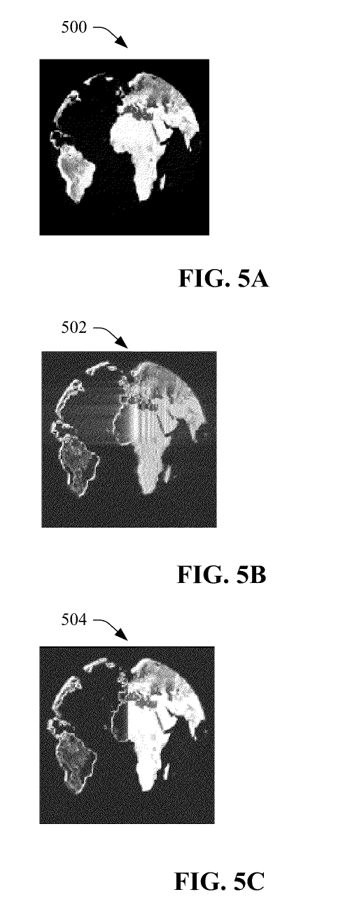

FIG. 5A illustrates an example image 500 of a hemisphere with the texture of an Earth image that has a radius of 0.5 millimeters (mm) with its tip located at 0.3 m from the hologram. The hologram is generated using Equation (1) and the target effect is to enhance the edges at the left half side of the hemisphere. FIG. 5B depicts an example reconstructed holographic image 502 (e.g., numerical reconstructed image) produced from the hologram of the hemisphere with the texture of the Earth image positioned at 0.3 m from the hologram plane, wherein the hologram has been subject to high pass filtering on the left half plane (e.g., wherein high pass filtering has been applied to the hologram on the left half plane). The reconstructed holographic image 502, which is focused at 0.3 m, has had a high-boost filter applied directly to the left side of the digital hologram of the hemisphere. As observed in the experimental results, and as can be observed in the reconstructed holographic image 502, the edges on the left side of the reconstructed holographic image 502 have been strengthened after direct application of the high-boost filter to the hologram, however, the image 502, particularly on its right side, is significantly distorted. FIG. 5C illustrates an example reconstructed holographic image 504 (e.g., numerical reconstructed image) produced from the hologram of the hemisphere with the texture of the Earth image positioned at 0.3 m from the hologram plane, wherein the VDP of the hologram has been subject to high pass filtering on the left half plane (e.g., wherein high pass filtering has been applied to the VDP of the hologram on the left half plane), in accordance with various aspects and embodiments of the disclosed subject matter. With regard to the reconstructed holographic image 504, a VDP was derived, high-boost filtering was applied to the left side of the VDP, and the processed (e.g., filtered or enhanced) VDP was expanded to generate the reconstructed holographic image 504, in accordance with various aspects and embodiments of the disclosed subject matter (e.g., using the hologram enhancer component 106). As observed in the experimental results, and as can be observed in the reconstructed holographic image 504, the edges on the left side of the image 504 of the hemisphere are strengthened, while the rest of the image 502 (e.g., the right-side of the image 502) remain unaffected or at least remain substantially unaffected as a result of the application of the high-boost filter to the VDP.

Another desirable enhancement technique that can be used to enhance visual images is a relighting technique. In photography, relighting can be a desirable (e.g., important) technique that can enable the optical properties of a picture to be modified to enhance the visual quality of the photograph, or to create special effects that are absent in the image acquisition process, without having to retake the picture again. Relighting can allow the optical properties, such as illumination, which may be difficult to control in the real world environment, to be synthesized or modified.

With photographs, relighting can be performed by varying the value of individual pixels according to a given criteria, in an operation that is commonly referred to as the “point” process, because each of those pixels represents local information associated with the pixel. For example, using a relighting technique, the effect of a spotlight can be simulated in a digital photograph by modulating the luminance of each pixel of the digital photograph with the spatial distribution of the illumination.

It can be desirable to apply a relighting mechanism and/or technique to digital holograms to enhance their impact to the observers. However, the problem is, rendering a digital hologram with the “point” process can be erroneous, as each pixel can be representing holistic information from the entire 3-D object scene. That is, as with other enhancement techniques (e.g., sharpening, histogram equalization, etc.), in contrast to a photograph, a digital hologram cannot be desirably relit by simply varying the value of individual pixels of the hologram because each pixel in the hologram can be representing holistic information of the entire 3-D object scene rather than merely local information associated with the pixel.

A straightforward solution to the problem of relighting digital holograms can be to render the original object scene, if it is still available, whenever a relighting task is required, and then regenerate the hologram afterwards. Despite the effectiveness and simplicity of this technique, the process can be time-consuming as the numerical generation of a digital hologram can involve an enormous amount of arithmetic operations. Although there are quite a number of conventional algorithms, which may be used to attempt to alleviate this problem, these conventional algorithms are not capable of generating holograms in real time (e.g., at the video frame rate) if there are a large number of object points. Further, if the digital hologram is captured with optical means, the original object scene may not be available afterwards. In such a case, theoretically some sort of inverse mapping can be applied to reconstruct, and then relight the scene image. Subsequently, the rendered scene image can be converted into a hologram. However, the inverse process itself can be complicated. Further, thus far only the reconstruction of holograms representing sparse images (e.g., images that contain a relatively few number of object points) have been successfully demonstrated.

The disclosed subject matter can overcome these and other problems presented in connection with relighting digital holograms. The disclosed subject matter, using the hologram enhancer component 106, can employ a fast technique for relighting digital hologram (e.g., in real time or at least near real time) without the presence, or the reconstruction of the original object scene. In some implementations, the hologram enhancer component 106 can relight (e.g., in real or at least near real time) digital holograms using a wavefront recording plane technique to facilitate enhancing the visual quality of holographic images of the digital holograms.

The hologram enhancer component 106 can project a digital hologram (e.g., 3-D digital hologram) onto a WRP which can be placed in relatively close proximity (e.g., sufficiently near) to the object points in the object scene (e.g., 3-D object scene). A WRP can be a type of, or can be an alternative name for a, VDP. For instance, a VDP can be a generalized form of a WRP and/or a VDP can be an extension of a WRP. At close proximity, each object typically will only cast its optical wave on a small region on the WRP. Hence, relighting the intensity of a pixel in the WRP, by the hologram enhancer component 106, can be equivalent to modifying the intensities of a small cluster of object points that can be contributing to the pixel of interest. On this basis, the hologram enhancer component 106 can apply desired relighting to the WRP. As more fully disclosed herein, once the desired relighting has been applied to the WRP to generate a processed WRP, the hologram enhancer component 106 can expand the processed WRP to generate a full digital hologram. As more fully disclosed herein, the relighting process can mainly involve four Transform (FFT) operations which typically can be realized with a GPU in less than 20 ms for a hologram comprising 2048×2048 pixels. Experimental results have demonstrated that the target relighting effects can be desirably (e.g., correctly) synthesized in the reconstructed images of holograms that are relight using the relighting technique of the disclosed subject matter.

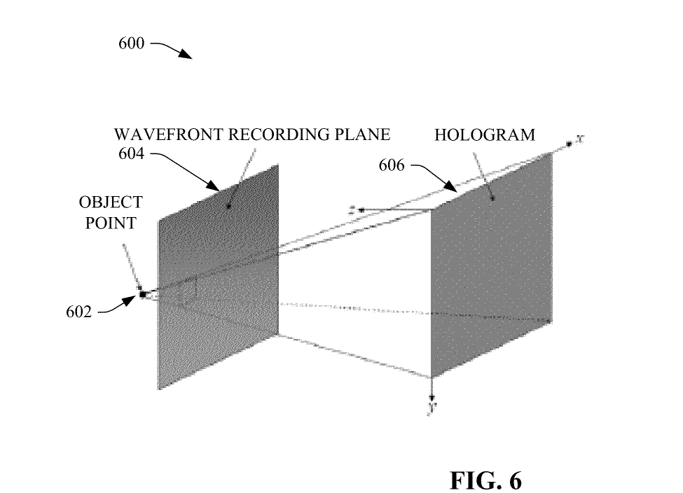

Turning to FIG. 6 (along with FIG. 1), FIG. 6 illustrates a diagram of an example image 600 that can depict a spatial relation between an object point of a 3-D object scene, a WRP, and a hologram that can represent the 3-D object scene, in connection with employing a relighting technique to facilitate relighting the hologram, in accordance with various aspects and embodiments of the disclosed subject matter. The example illustration 600 can include the object point 602, which can be one of a plurality of object points that can be representative of the original object scene (e.g., original 3-D object scene). The example illustration 600 also can include the WRP 604 and the digital hologram 606 (e.g., 3-D digital hologram, which can be representative of the original 3-D object scene.

In some implementations, the hologram enhancer component 106 can facilitate inserting a hypothetical or virtual diffraction plane, such as the WRP 604, between the digital hologram 606 and the object scene, comprising the object point 602. Given an arbitrary object point (e.g., object point 602) of the object scene, the optical wave of such object point can propagate by diffraction to the entire hologram (e.g., digital hologram 606). Other object points in the scene can contribute to the hologram in a similar manner. Hence, modifying a hologram pixel will affect the diffracted waves contributed by the entire scene image, instead of localizing in the region around the pixel of interest. However, as shown in the illustration 600, an object point 602 will only cover a small area 608 (e.g., the dotted region) on the WRP 604. The closer the distance between the object point 602 and the WRP 604, the smaller will be the coverage (e.g., the support) of the diffraction pattern on the WRP 604. As such, relighting a pixel in the WRP 604 generally will only affect the diffraction pattern of a small cluster of object points that share the same support in the WRP 604.

The disclosed relighting technique can be realized through a multi-stage (e.g., three-stage) process. The hologram enhancer component 106 can determine, derive, or generate the WRP 604 based at least in part on a relationship between the object points (e.g., 602) in a 3D object scene, the field distribution on WRP 604, u_{w}(x, y), and the hologram 606, u(x, y). These three entities (e.g., object points of the 3-D object scene, WRP, and hologram) can be assumed to have the same horizontal and vertical extents of X and Y units. The complex wavefront contributed by the object points 602 on the WRP 604 can be given, for example, by Equation (13) as follows:

$${u}_{w} ( x , y ) = {\sum }_{j = 0}^{N - 1} \frac{{a}_{j}}{{R}_{wj}} exp ( i \frac{2 π}{λ} {R}_{wj} ) , \qquad ( 13 )$$

where 0<xⱼ<X and 0<yⱼ<Y are the horizontal and vertical positions of the jth object point 602; aⱼ and R_{wj}=\sqrt{(x−xⱼ)²+(y−yⱼ)²+dⱼ²} are the amplitude of the ‘jth’ object point 602 and its distance from the WRP 604, respectively; dⱼ is the perpendicular distance from the jth object point 602 to the WRP 604 and λ is the wavelength of the reference light. As the object scene can be in close proximity (e.g., very close) to the WRP 604, the diffracted beam of each object point 602 only covers a relatively small square window of size W×W (e.g., the support 608). As such, Equation (13) can be rewritten, for example, as Equation (14) as follows:

$${u}_{w} ( x , y ) = {\sum }_{j = 0}^{N - 1} {F}_{j} , \\ where \\ {F}_{j} = \{ \begin{matrix}\frac{{a}_{j}}{{R}_{wj}} exp ( i \frac{2 π}{λ} {R}_{wj} ) & if \vert x - {x}_{j} \vert and \vert y - {y}_{j} \vert < \frac{1}{2} W \\ 0 & otherwise .\end{matrix} \qquad ( 14 )$$

The hologram enhancer component 106 can expand the WRP 604 to a hologram 606, u (x, y), for example, using the following Equation (15):

u(x,y)=KF⁻¹┐F[u_{w}(x,y)]·F[h(x,y)]┌, (15)

where F[{sub-equation}] and F⁻¹{sub-equation}] can denote the forward FFT and inverse FFT, respectively;

$$K = - \frac{i}{λ {z}_{w}} exp ( i \frac{2 π z}{λ} )$$

can be a constant; and

$$h ( x , y ) = exp ( i \frac{π}{λ {z}_{w}} ( {x}^{2} + {y}^{2} ) )$$

can be a fixed impulse function for a given separation z_{w} between the WRP 604 and the hologram 606. From Equation (15), the hologram enhancer component 106 can determine the inverse process projecting the hologram 606 to the WRP 604, for example, using Equation (16) as follows:

$${u}_{w} ( x , y ) = \frac{1}{K} {F}^{- 1} ⌊ \frac{F [ u ( x , y ) ]}{F [ h ( x , y ) ]} ⌋ \qquad ( 16 )$$

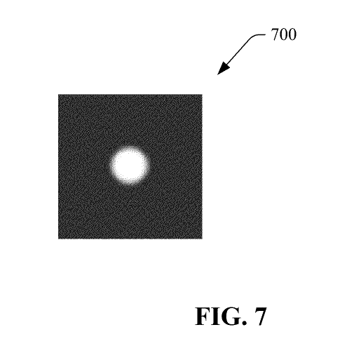

In this stage of the multi-stage process, the WRP 604 obtained, for example, using Equation (16), can be modulated with the relighting image (RI), G(x, y), that can simulate a given relighting condition. Referring briefly to FIG. 7 (along with FIGS. 1 and 6), FIG. 7 illustrates an example relighting image 700 that can be employed to facilitate relighting all or a portion of a hologram, in accordance with various aspects and embodiments of the disclosed subject matter. For example, the RI 700 can emphasize the intensity within a circular region around the center of the object scene, which can thereby create the effect of a spotlight. The relit WRP 604 (e.g., the WRP 604, as processed or relit) can be determined, for example, by Equation (17) as follows:

u_{w}^{L}(x,y)=G(x,y)u_{w}(x,y) (17)

The hologram enhancer component 106 can expand the relit WRP 604, u_{w}^{L}(x, y), to a hologram (e.g., hologram 606, as processed via the disclosed relighting process), for example, using the following Equation (18) as follows:

u^{L}(x,y)=KF⁻¹┐F[u_{w}^{L}(x,y)]·F[h(x,y)]┌. (18)

The relighting process of disclosed subject matter can involve four FFT operations (two FFT operations in Equation (16) and two FFT operations in Equation (18)), which can constitute a substantial amount of the arithmetic operations associated with the disclosed relighting process. In some implementations, the hologram enhancer component 106 (or another component) can pre-calculate the pair of terms,

$$\frac{1}{F [ h ( x , y ) ]} and F ⌊ h ( x , y ) ⌋ ,$$

store the respective results of those calculations in a look up table (LUT), which can be stored in a data store, for example. This can facilitate reducing the computation load and processing time during the processing and generation of holograms. With a computing system employing a GPU, the four FFTs typically can be executed in less than 20 ms. The computation time for the remainder of the disclosed relighting process, comprising multiplication between pairs of 2-D arrays (e.g. Equation (17)), can be negligible.

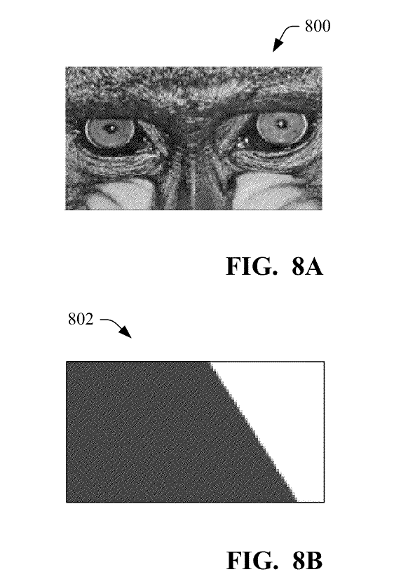

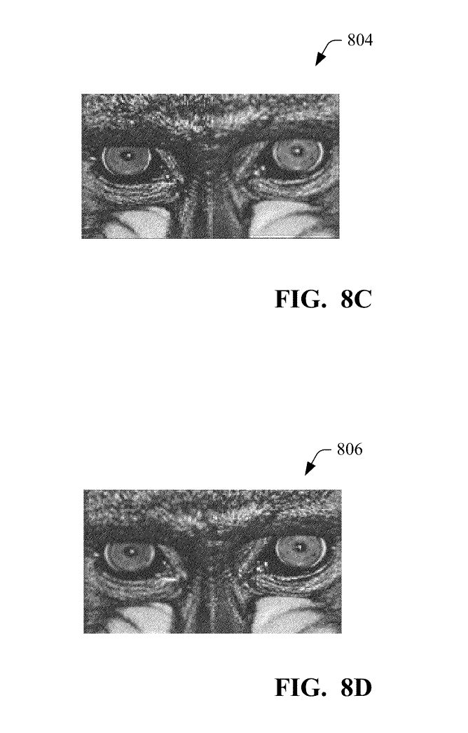

Referring to FIG. 8A, presented is an example scene image 800 that is a double-depth image that is partitioned into left and right sections positioned at 0.58 m and 0.6 m from the hologram plane, respectively. A digital Fresnel hologram is generated with a “point-light” method. The wavelength of the optical beam and the pixel size of the hologram are 650 nm and 7 um, respectively. FIG. 8B depicts an example relighting image 802, G(x, y), that is employed to simulate the directional illumination emerging from the upper right corner. The relighting image 802, G(x, y), is divided into an illuminated region (the white area) and a shadow region (the grey area) that are separated by a sharp boundary. When relighting is not applied, the numerical reconstructed images 804 and 806, respectively, representing the scene image 800 at the two depth planes (e.g., 0.58 m and 0.6 m, respectively) are shown in FIGS. 8C and 8D. When either side of the reconstructed image is in focus, it is a good recovery of the original content.

Using a conventional relighting method, the hologram is relit directly with G(x, y) by multiplying the two images, numerical reconstructed images 804 and 806, on a pixel-by-pixel basis. A hologram u(x, y), after direct relighting with an image G(x, y), is given by Equation (19) as follows:

u_{D}^{L}(x,y)=u(x,y)G(x,y). (19)

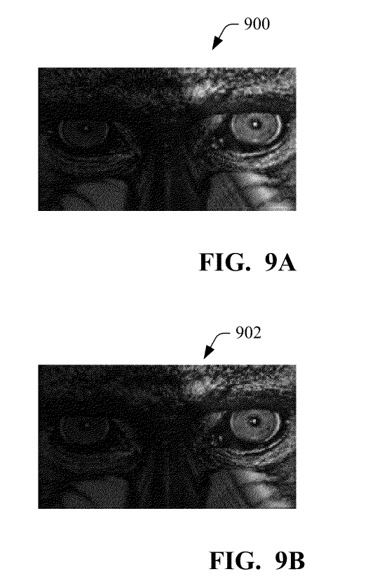

The numerical reconstructed images 900 and 902, respectively, of the hologram u_{D}^{L}(x, y) after conventional direct relighting at the two depth planes are shown in FIGS. 9A and 9B, wherein the numerical reconstructed image 900 has been directly relit with the relighting image 802 depicted in FIG. 8B at a focal distance of 0.5 m, and the numerical reconstructed image 902 has been directly relit with the relighting image 802 depicted in FIG. 8B at a focal distance of 0.6 m.

As the experimental results show, and as can be seen in the reconstructed images 900 and 902, the relighting effect is not totally in line with the relighting image. Notably, the boundary between the illuminated and the shadow regions appear to be fuzzy, and the area around it appears to be heavily contaminated with slanting bars. The defects exhibited in FIGS. 9A and 9B are expected, as direct modification of a small part of the hologram typically will change the diffraction waves contributed by the entire object scene instead of localizing in the neighborhood of the modified area.

To overcome such deficiencies in relighting holograms using conventional relighting methods, the hologram enhancer component 106 can apply the disclosed relighting process to relight the digital hologram via use of a WRP. In accordance with the disclosed subject matter, the digital hologram was converted to the WRP, u_{w}(x, y), based on Equation (16), which is multiplied with the relighting image G(x, y). The result for the WRP was expanded into a relighted hologram based on Eq. (18).

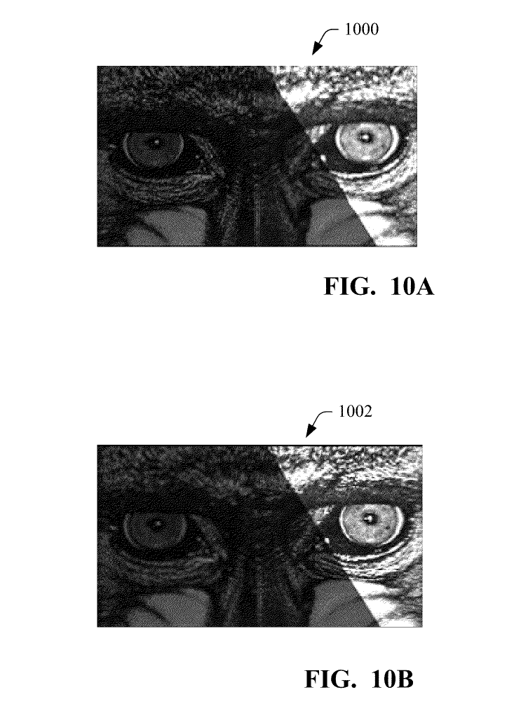

FIGS. 10A and 10B respectively present the reconstructed images 1000 and 1002 of the relighted hologram at the two depth planes, in accordance with aspects and embodiments of the disclosed subject matter. The reconstructed image 1000 is a numerical reconstructed image of the digital hologram, which was relighted using the disclosed relighting process based on the relighting of the scene image 800 in FIG. 8A at a focal distance of 0.5 m. The reconstructed image 1002 is a numerical reconstructed image of the digital hologram, which was relighted using the disclosed relighting techniques based on the relighting of the scene image 800 in FIG. 8A at a focal distance of 0.6 m. It can be observed that the relighting effect for the reconstructed images 1000 and 1002 is in good or at least substantially good agreement with the relighting image 802 of FIG. 8B, with a clear boundary between the illuminated and the shadow regions.

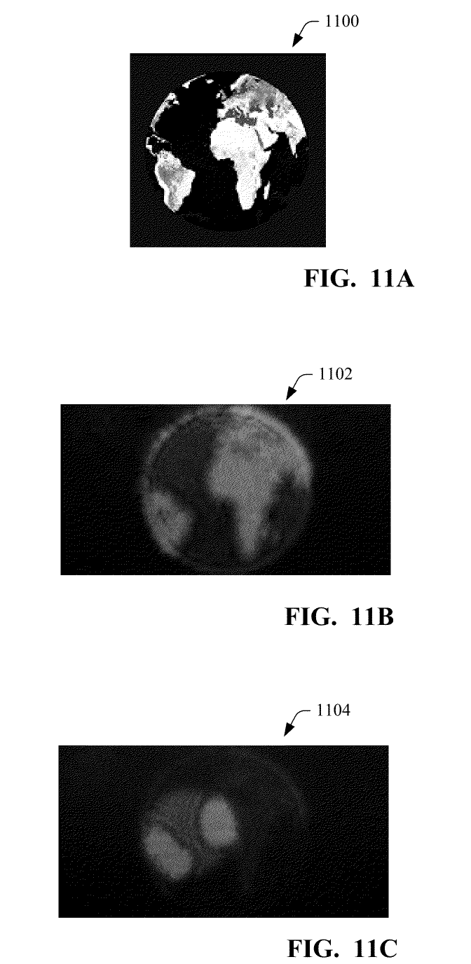

FIGS. 11A, 11B, and 11C present respective images 1100, 1102, and 1104 to further illustrate the disclosed relighting process to relight a digital hologram via use of a WRP, in accordance with various aspects and embodiments of the disclosed subject matter. FIG. 11A illustrates an image 1100 of a digital hologram, u(x, y), of a hemisphere that has been rendered with the texture of the earth image. The hemisphere has a radius of 0.005 m, with the tip located at 0.001 m from the WRP and at 0.3 m from the hologram. A real, off-axis hologram, H (x, y), is generated by adding a planar reference wave, R(y), which is illuminating at an inclined angle 1.2° on the hologram, to u(x, y), and taking the real part of the result to give

H(x,y)=RE┐u(x,y)·R(y)┌, (20)

where RE[{sub-equation}] denotes the real part of a complex variable. The real, off-axis hologram is displayed on an LCOS display device modified from the Sony VPL-HW15 Bravia projector having a horizontal and vertical resolution of 1920 pixels and 1080 pixels, respectively, and a dot-pitch of 7 um. FIG. 11B presents the optical reconstructed image 1102 displayed on the LCOS display device.

Subsequently, the disclosed relighting process, use a WRP, was applied to relight the hologram u(x, y) using the relighting image 700 shown in FIG. 7. The relighting image 700 is translated horizontally in a back and forth manner to generate the effect of a panning spotlight. Each relight hologram, corresponding to a particular spotlight position, was then converted into a real hologram based on Eq. (20), and reconstructed on the LCOS display device. FIG. 11C presents an optical reconstructed image 1104 of the hologram representing the hemisphere in FIG. 11A. The optical reconstructed image 1104 is an image of a single frame excerpt of an optical reconstructed holographic animation clip. The clip was showing at a rate of 12 frames per second. It can be observed from the excerpt, the optical reconstructed image 1104, as well as in the optical reconstructed holographic animation clip, that the effect of the panning spotlight is correctly generated in the sequence of reconstructed holographic images.

The disclosed subject matter, employing the holographic enhancer component 106 and other components, also can apply various other types of relighting functions to facilitate relighting holographic images (e.g., in real time or at least near real time). For example, the disclosed subject matter, employing the holographic enhancer component 106 and other components, can apply relighting functions, including sophisticated types of relighting functions image-based and geometry-based relighting functions, to facilitate relighting holograms quickly (e.g., in real time or at least near real time), while producing holographic images of desirable quality (e.g., desirably relit).

With further regard to the displaying of holographic images, with the hologram generated, the HGC 102 can provide (e.g., communicate) the 3-D hologram, in real time or via recorded media (e.g., 2-D media, such as film), to the display component 104. The display component 104 can generate, reconstruct, or reproduce 3-D holographic images (e.g., full-parallax 3-D Fresnel holographic images) that can represent or recreate the original 3-D object scene, based at least in part on the 3-D hologram, and can present (e.g., display) the 3-D holographic images for viewing by one or more viewers from various visual perspectives. In some implementations, the HGC 102 and the display component 104 can operate in conjunction with each other to facilitate generating, reconstructing, or reproducing the 3-D holographic images that can represent or recreate the original 3-D object scene, based at least in part on the 3-D hologram, for presentation, by the display component 104.

The display component 104 can include one or more display units (e.g., one or more electronically accessible display units, wherein each pixel of a display unit(s) can be electronically accessible). In some implementations, each display unit can be a low-resolution display device, such as a low-resolution LCD or low-resolution SLM. For example, each display unit can have a dot-pitch that can be at least one order of magnitude higher than the wavelength of visible light. In other implementations, the display component 104 can comprise one or more of LCOS displays, high-resolution LCDs, autostereoscopic displays (e.g., multiple-section autostereoscopic displays (MSADs)), holographic 3-D television (TV) displays, high-resolution SLMs, or other desired displays suitable for displaying holographic images (e.g., 3-D Fresnel holographic images), to facilitate displaying (e.g., real time displaying) of holographic images.

In some implementations, the display component 104 can include a display unit that can include real binary display unit that can display each pixel as being either transparent or opaque. In other implementations, the display component 104 can include multiple display units (e.g., a pair of display units), which can be binary display units, wherein one display unit can display the real part of the hologram and the other display unit can display the imaginary part of the hologram. The display component 104 can combine the pair of binary display units using optical means, and each pixel can be either transparent or opaque.

In still other implementations, the display component 104 can include a single, discrete multi-level display unit that can display each pixel respectively having a transparency level from a set of allowable transparency levels, with the set of allowable transparency levels comprising respective transparency levels ranging from transparent to opaque. In other implementations, the display component 104 can comprise multiple (e.g., a pair) of discrete, multi-level display units, wherein one display unit can display the real part of the hologram and another display unit can display the imaginary part of the hologram, and each pixel can have a respective transparency level from the set of allowable transparency levels.

Additionally and/or alternatively, if desired, a hologram can be produced onto a desired material (e.g., onto film using photographic techniques) so that there is a hard copy of the hologram that can be used to reproduce the 3-D holographic images at a desired time. In some implementations, the HGC 102 can generate the digital hologram using a single static media, such as a photographic film or a printout, and the display component 104 can display the hologram, wherein the static media can display the real part of the hologram. In other implementations, the HGC 102 can generate the digital hologram using a multiple (e.g., a pair) of static media (e.g., photographic film or printouts), and the display component 104 can display the hologram, wherein one static media can display the real part of the hologram and another static media can display the imaginary part of the hologram.

It is to be appreciated and understood that the holographic output (e.g., 3-D hologram and/or corresponding 3-D holographic images) can be communicated over wired or wireless communication channels to the display component 104 or other display components (e.g., remote display components, such as a 3-D TV display) to facilitate generation (e.g., reconstruction, reproduction) and display of the 3-D holographic images of the 3-D object scene) so that the 3-D holographic images can be presented to desired observers.

The system 100 and/or other systems, methods, devices, processes, techniques, etc., of the disclosed subject matter can be employed in any of a number of different applications. Such applications can include, for example, a 3-D holographic video system, desktop ornaments, attractions in theme parks, educational applications or purposes, a holographic studio, scientific research, live stage or concerts, etc.

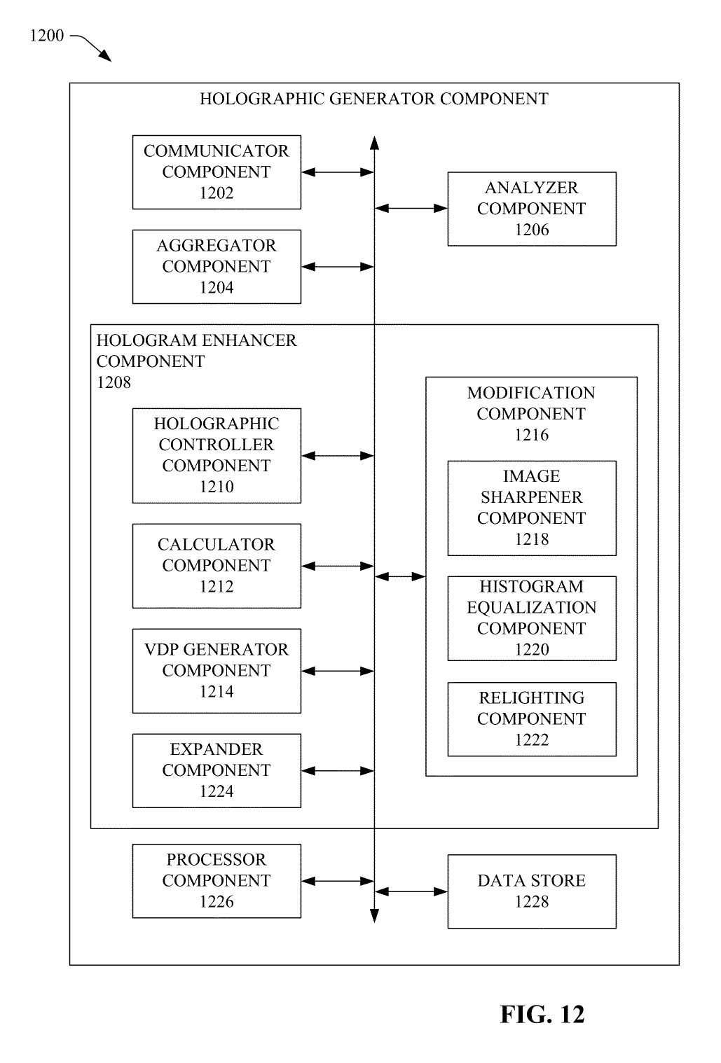

FIG. 12 illustrates a block diagram of an example HGC 1200 that can efficiently generate (e.g., in real or at least near real time) a 3-D hologram(s) (e.g., a modified or an enhanced 3-D Fresnel hologram(s)) of a real or synthetic 3-D object scene(s), in accordance with various aspects and implementations of the disclosed subject matter. The HGC 1200 can include a communicator component 1202 that can be used to communicate (e.g., transmit, receive) information between the HGC 1200 and other components (e.g., display component(s), scene capture device(s), processor component(s), user interface(s), data store(s), etc.). The information can include, for example, a real or synthetic 3-D object scene, holograms or holographic images, information relating defined hologram generation criterion(s), information relation to an algorithm(s) that can facilitate generation of holograms or holographic images, etc.

The HGC 1200 can comprise an aggregator component 1204 that can aggregate data received (e.g., obtained) from various entities (e.g., scene capture device(s), display component(s), processor component(s), user interface(s), data store(s), etc.). The aggregator component 1204 can correlate respective items of data based at least in part on type of data, source of the data, time or date the data was generated or received, object point with which data is associated, pixel with which a transparency level is associated, visual perspective with which data is associated, etc., to facilitate processing of the data (e.g., analyzing of the data by the analyzer component 1206).

The analyzer component 1206 can analyze data to facilitate generating a hologram associated with an object scene, generating a VDP associated with an object scene, processing a VDP to facilitate generating a processed VDP, modifying optical properties associated with a VDP associated with an object scene, determining a visual effect (e.g., sharpening, histogram equalization, etc.) to apply to a VDP to facilitate generating a processed hologram that comprises desired optical characteristics, determining a target adjustment in the optical properties of a VDP to facilitate producing a target adjustment to the optical characteristics of a hologram associated with the VDP, identifying elements (e.g., object points, features, etc.) of a 3-D object scene, etc., and can generate analysis results, based at least in part on the data analysis. Based at least in part on the results of this analysis, the HGC 1200 (e.g., using the hologram enhancer component 1208) can generate a VDP based at least in part on a hologram associated with an object scene, process the VDP to modify optical properties of the VDP to generate a processed VDP, and expand the processed VDP to generate a processed hologram that can comprise optical characteristics that can be modified from the original hologram based at least in part on the modified optical properties associated with the processed VDP.

The HGC 1200 can include the hologram enhancer component 1208 that can process a hologram to facilitate modifying the optical characteristics of the hologram to facilitate modifying (e.g., enhancing) holographic images that can represent the object scene asscociated with the hologram. The hologram enhancer component 1208 can generate a VDP based at least in part on a hologram associated with an object scene, process the VDP to modify optical properties of the VDP to generate a processed VDP, and expand or convert the processed VDP to generate a processed hologram that can comprise optical characteristics that can be modified from the original hologram based at least in part on the modified optical properties associated with the processed VDP. In some implementations, the hologram enhancer component 1208 can comprise, for example, a holographic controller component 1210, a calculator component 1212, a VDP generator component 1214, a modification component 1216, an image sharpener component 1218, a histogram equalization component 1220, a relighting component 1222, and an expander component 1224.

The holographic controller component 1210 can control operations relating to processing and generating a hologram (e.g., full-parallax 3-D Fresnel hologram) and/or corresponding holographic images. The holographic controller component 1210 can facilitate controlling operations being performed by various components of the hologram enhancer component 1208, controlling data flow between various components of the hologram enhancer component 1208, controlling data flow between the hologram enhancer component 1208 and other components of the HGC 1200, etc.

The calculator component 1212 can perform calculations on data (e.g., data with respective values), in accordance with various equations (e.g., mathematical expressions), to facilitate generating a hologram, generating a VDP associated with a hologram, modifying optical properties of a VDP associated with a hologram to facilitate generating a processed VDP, expanding or converting a processed VDP to generate a processed hologram based at least in part on the processed VDP, etc. The calculator component 1212 can facilitate calculating, for example, calculating results for one or more equations relating to generating holograms, including the equations disclosed herein.

The VDP generator component 1214 can generate a VDP based at least in part on a hologram that can represent an object scene. The VDP generator component 1214 can facilitate projecting (e.g., back projecting) a hologram to generate a virtual or hypothetical two-dimensional (2-D) image that can be a VDP based at least in part on the object scene.

The modification component 1216 can facilitate modifying (e.g., enhancing) optical properties associated with a VDP to facilitate modifying optical characteristics of a hologram to facilitate generating a processed hologram comprising the modified optical characteristics. The modification component 1216 can employ one or more visual effects, filters, techniques, etc., to facilitate modifying the optical properties associated with the VDP. The modification component 1216 can include the image sharpener component 1218, wherein the image sharpener component 1218 can employ one or more sharpening filters (e.g., a high-boost sharpening filter) that can filter a region(s) of a VDP associated with a hologram to facilitate sharpening a region(s) of a hologram that corresponds to the region(s) of the VDP to facilitate generating a processed hologram that comprises such region(s) as sharpened by the one or more sharpening filters.

The modification component 1216 also can include the histogram equalization component 1220, wherein the histogram equalization component 1220 can apply histogram equalization to a VDP to facilitate adjusting the contrast or other optical properties of the VDP. The histogram equalization component 1220 can employ a histogram equalization process that can be modified or tailored to enable histogram equalization to be applied to a VDP, as compared to histogram equalization that can be applied to a digital photograph.

The modification component 1216 further can comprise the relighting component 1222 that can relight a region(s) of a VDP (e.g., WRP) associated with a hologram to facilitate relighting a region(s) of a hologram that corresponds to the region(s) of the VDP to facilitate generating a processed hologram that comprises such relighted region(s).

The expander component 1224 can facilitate expanding or converting a processed VDP (e.g., WRP) associated with a hologram to facilitate generating a processed hologram that can have optical charactistics that can correspond to modifications made by the hologram enhancer component 1208 to the optical properties of the VDP. For example, the expander component 1224 can expand a processed (e.g., enhanced or modified) VDP (e.g., WRP) in part by diffracting the processed VDP back to the original plane of the digital hologram to facilitate generating a processed (e.g., enhanced or modified) digital hologram.

The HGC 1200 also can comprise a processor component 1226 that can operate in conjunction with the other components (e.g., communicator component 1202, aggregator component 1204, analyzer component 1206, hologram enhancer component 1208, etc.) to facilitate performing the various functions of the HGC 1200. The processor component 1226 can employ one or more processors (e.g., central processing units (CPUs), GPUs, FPGAs, etc.), microprocessors, or controllers that can process data, such as information (e.g., visual information) relating to an object scene (e.g., 3-D object scene), holographic data, data relating to parameters associated with the HGC 1200 and associated components, etc., to facilitate generating holograms (e.g., full-parallax 3-D Fresnel holograms) and corresponding holographic images representative of a 3-D object scene; and can control data flow between the HGC 1200 and other components associated with the HGC 1200.

In yet another aspect, the HGC 1200 can contain a data store 1228 that can store data structures (e.g., user data, metadata); code structure(s) (e.g., modules, objects, classes, procedures), commands, or instructions; information relating to object points; information relating to (e.g., representative of) an object scene; holographic data; information relating to VDPs; parameter data; algorithms (e.g., algorithm(s) relating to generating a VDP based on a hologram; algorithm(s) relating to expanding a processed VDP to generate a processed hologram; etc.); criterion(s) relating to hologram generation; and so on. In an aspect, the processor component 1226 can be functionally coupled (e.g., through a memory bus) to the data store 1228 in order to store and retrieve information desired to operate and/or confer functionality, at least in part, to the communicator component 1202, aggregator component 1204, analyzer component 1206, hologram enhancer component 1208, etc., and/or substantially any other operational aspects of the HGC 1200. It is to be appreciated and understood that the various components of the HGC 1200 can communicate information between each other and/or between other components associated with the HGC 1200 as desired to carry out operations of the HGC 1200. It is to be further appreciated and understood that respective components (e.g., communicator component 1202, aggregator component 1204, analyzer component 1206, hologram enhancer component 1208, etc.) of the HGC 1200 each can be a stand-alone unit, can be included within the HGC 1200 (as depicted), can be incorporated within another component of the HGC 1200 (e.g., hologram enhancer component 1208) or component separate from the HGC 1200, and/or virtually any suitable combination thereof, as desired.

It is to be appreciated and understood that, in accordance with various other aspects and embodiments, the HGC 1200 or components associated therewith can include or be associated with other components (not shown for reasons of brevity), such as, for example, a modeler component (e.g., to facilitate generating model data that can be used to generate or display a hologram), adapter components (e.g., to facilitate adapting or modifying holographic images or data to facilitate desirably generating or displaying the hologram), a reference beam component (e.g., to apply a reference beam to a 3-D object scene and/or a 3-D hologram), a render component (e.g., to render or convert data, such as model data or diffraction pattern data, associated with the 3-D object scene into corresponding holographic data, which can be used to generate a hologram that is a reproduction of the 3-D object scene), a reflector component(s) (e.g., to reflect holographic images to facilitate display of the hologram), and/or display partitions (e.g., to partition a display into a desired number of partitions in order to show different views of the hologram), etc., that can be employed to facilitate generating a hologram and/or generating or displaying corresponding holographic images representing a 3-D object scene.

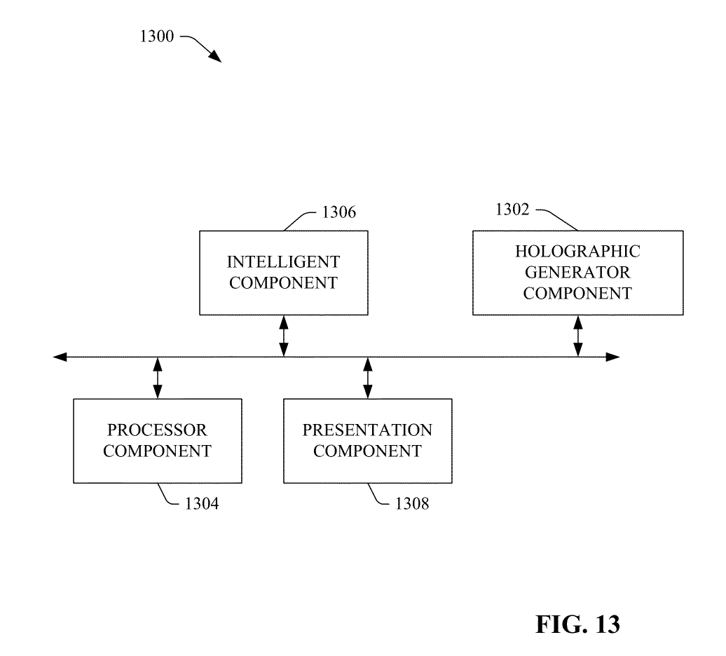

Referring to FIG. 13, depicted is a block diagram of a system 1300 that can employ intelligence to facilitate enhancing and generating a 3-D hologram (e.g., a modified or an enhanced full-parallax 3-D Fresnel hologram) of a real or synthetic 3-D object scene in accordance with an embodiment of the disclosed subject matter. The system 1300 can include an HGC 1302 that can desirably generate a hologram (e.g., sequence of 3-D holographic images) that can represent a 3-D object scene (e.g., real or computer-synthesized 3-D object scene from multiple different viewing perspectives of a 3-D object scene that can correspond to multiple different viewing perspectives of the 3-D object scene), as more fully disclosed herein. It is to be appreciated that the HGC 1302 can be the same or similar as respective components (e.g., respectively named components), and/or can contain the same or similar functionality as respective components, as more fully described herein. The HGC 1302 can include a hologram enhancer component (not shown in FIG. 13; e.g., as depicted in, or described herein in relation to, FIGS. 1 and 12) that can modify (e.g., enhance, adjust, etc.) and generate a full-parallax digital 3-D hologram (e.g., Fresnel hologram) to facilitate generating or reconstructing full-parallax digital 3-D holographic images (e.g., 3-D Fresnel holographic images) that can represent or recreate the original real or synthetic 3-D object scene, as more fully disclosed herein.

The system 1300 can further include a processor component 1304 that can be associated with (e.g., communicatively connected to) the HGC 1302 and/or other components (e.g., components of system 1300) via a bus. In accordance with an embodiment of the disclosed subject matter, the processor component 1304 can be an applications processor(s) that can manage communications and run applications. For example, the processor component 1304 can be a processor that can be utilized by a computer, mobile computing device, personal data assistant (PDA), or other electronic computing device. The processor component 1304 can generate commands in order to facilitate, modifying holograms, generating holograms, and/or displaying of holographic image of a 3-D object scene from multiple different viewing perspectives corresponding to the multiple different viewing perspectives of the 3-D object scene obtained or created by the HGC 1302, modifying parameters associated with the HGC 1302, etc.

The system 1300 also can include an intelligent component 1306 that can be associated with (e.g., communicatively connected to) the HGC 1302, the processor component 1304, and/or other components associated with system 1300 to facilitate analyzing data, such as current and/or historical information, and, based at least in part on such information, can make an inference(s) and/or a determination(s) regarding, for example, modifying a VDP, generating a 3-D hologram (e.g., a hologram modified based at least in part on a modified VDP), and/or 3-D holographic image based at least in part on a 3-D object scene, setting of parameters associated with the HGC 1302 and associated components, etc.

For example, based in part on current and/or historical evidence, the intelligent component 1306 can infer or determine a type of visual effect to apply to a VDP to desirably enhance the visual quality or characteristics of a hologram; a desired (e.g., target) change in the optical properties of a VDP, or portion thereof, to facilitate making a desired (e.g., target) modification to a related hologram, or portion thereof; respective parameter values of one or more parameters to be used with regard to the performing of operations by the HGC 1302; etc.

In an aspect, the intelligent component 1306 can communicate information related to the inferences and/or determinations to the HGC 1302. Based at least in part on the inference(s) or determination(s) made by the intelligent component 1306, the HGC 1302 can take (e.g., automatically or dynamically take) one or more actions to facilitate generating a 3-D hologram and/or a 3-D holographic image of a 3-D object scene from multiple different viewing perspectives corresponding to the multiple different viewing perspectives of a 3-D object scene obtained or generated by the HGC 1302. For instance, the HGC 1302 can determine and/or select a type of visual effect to apply to a VDP (e.g., WRP) to desirably enhance the visual quality or characteristics of a hologram, determine and/or identify a desired (e.g., target) change in the optical properties of a VDP, or portion thereof, to facilitate making a desired (e.g., target) modification to a related hologram, or portion thereof, determine and/or select respective parameter values of one or more parameters to be used with regard to the performing of operations by the HGC 1302, etc., to facilitate generating a 3-D hologram and/or 3-D holographic images of a 3-D object scene.

It is to be understood that the intelligent component 1306 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data (e.g., historical data), whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

System 1300 also can include a presentation component 1308, which can be connected with the processor component 1304. The presentation component 1308 can provide various types of user interfaces to facilitate interaction between a user and any component coupled to the processor component 1304. As depicted, the presentation component 1308 is a separate entity that can be utilized with the processor component 1304 and associated components. However, it is to be appreciated that the presentation component 1308 and/or similar view components can be incorporated into the processor component 1304 and/or a stand-alone unit. The presentation component 1308 can provide one or more graphical user interfaces (GUIs) (e.g., touchscreen GUI), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into the processor component 1304.

The user can also interact with the regions to select and provide information via various devices such as a mouse, a roller ball, a keypad, a keyboard, a touchscreen, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance.

In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

In accordance with one embodiment of the disclosed subject matter, the HGC 1302 and/or other components, can be situated or implemented on a single integrated-circuit chip. In accordance with another embodiment, the HGC 1302, and/or other components, can be implemented on an application-specific integrated-circuit (ASIC) chip. In yet another embodiment, the HGC 1302 and/or other components, can be situated or implemented on multiple dies or chips.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

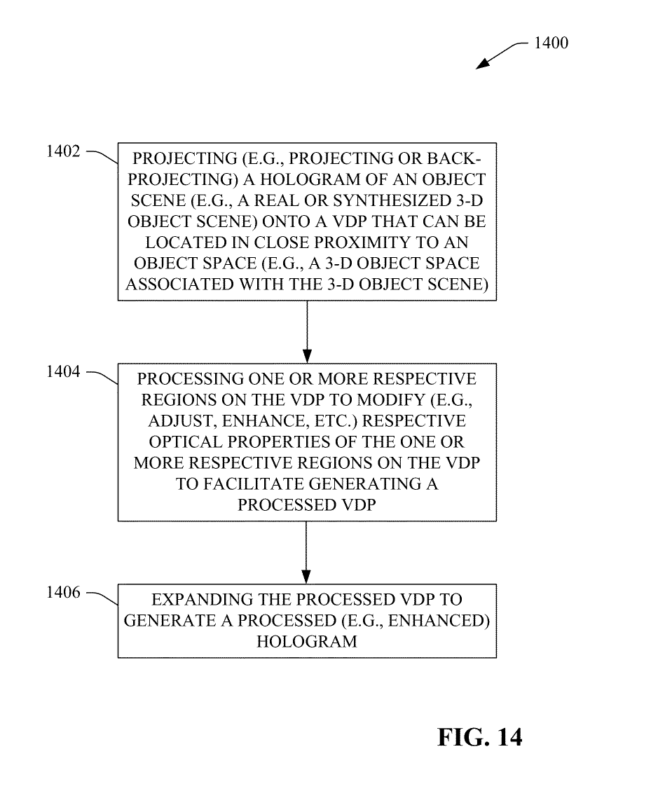

FIGS. 14-16 illustrate methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be further appreciated that the methods disclosed hereinafter and throughout this specification are capable of being stored on an article of manufacture to facilitate transporting and transferring such methods to computers. The term article of manufacture, as used herein, is intended to encompass a computer program accessible from any computer-readable device, carrier, or media.

Referring to FIG. 14, illustrated is a flow diagram of an example method 1400 for enhancing and generating (e.g., enhancing and generating in real or at least near real time) a 3-D hologram (e.g., an enhanced full-parallax 3-D Fresnel hologram of a real or synthetic 3-D object scene), in accordance with various embodiments and aspects of the disclosed subject matter. The method 1400 can be implemented by an HGC comprising a hologram enhancer component.

At 1402, a hologram of an object scene (e.g., a real or synthesized 3-D object scene) can be projected (e.g., projected or back-projected) onto a VDP that can be located in close proximity to (e.g., within a defined distance of) an object space (e.g., a 3-D object space associated with the 3-D object scene). The HGC can receive or generate the real or synthesized object scene, or can receive a hologram that can represent the real or synthesized object scene. In response to receiving a real object scene, the HGC can generate a hologram that can represent the object scene. The hologram enhancer component can project the hologram onto the VDP, which can be located within a desired defined (e.g., close) distance of the object space. A VDP can be a generalized form of a WRP and/or a VDP can be an extension of a WRP. That is, a WRP can be a type of VDP, or can be an alternative name for a VDP.

At 1404, one or more respective regions on the VDP can be respectively processed to modify (e.g., adjust, enhance, etc.) respective optical properties of the one or more respective regions on the VDP to facilitate generating a processed VDP. The hologram enhancer component can process the one or more respective regions on the VDP to modify the respective optical properties of the one or more respective regions on the VDP. For instance, the hologram enhancer component can process the one or more respective regions on the VDP to modify (e.g., adjust, enhance, etc.) optical (e.g., visual) characteristics (e.g., sharpness, contrast, brightness, illumination, etc.) of the one or more respective regions on the VDP. The hologram enhancer component can apply a sharpening filter(s), histogram equalization, a relighting process, or other visual effect or process, to the one or more respective regions on the VDP to facilitate modifying (e.g., adjusting, enhancing, etc.) the optical characteristics of the one or more respective regions on the VDP to facilitate making corresponding modifications to the optical characteristics of one or more respective corresponding regions on the hologram to facilitate generating a processed (e.g., enhanced) hologram.

At 1406, the processed VDP can be expanded to generate a processed (e.g., enhanced) hologram. The hologram enhancer component can expand the processed VDP to generate the processed hologram that can represent the object scene (e.g., to more closely represent the original 3-D object scene, or to modify certain optical characteristics of one or more regions of the hologram of the original 3-D object scene, or a combination thereof). For example, the hologram enhancer component can expand the processed VDP to generate the processed hologram using the techniques, algorithms, equations, etc., as more fully disclosed herein. A display component (e.g., LCOS display device(s)) can present holographic images (e.g., enhanced full-parallax 3-D Fresnel holographic images) that can represent the object scene based at least in part on the processed (e.g., enhanced) hologram (e.g., full-parallax 3-D Fresnel hologram).

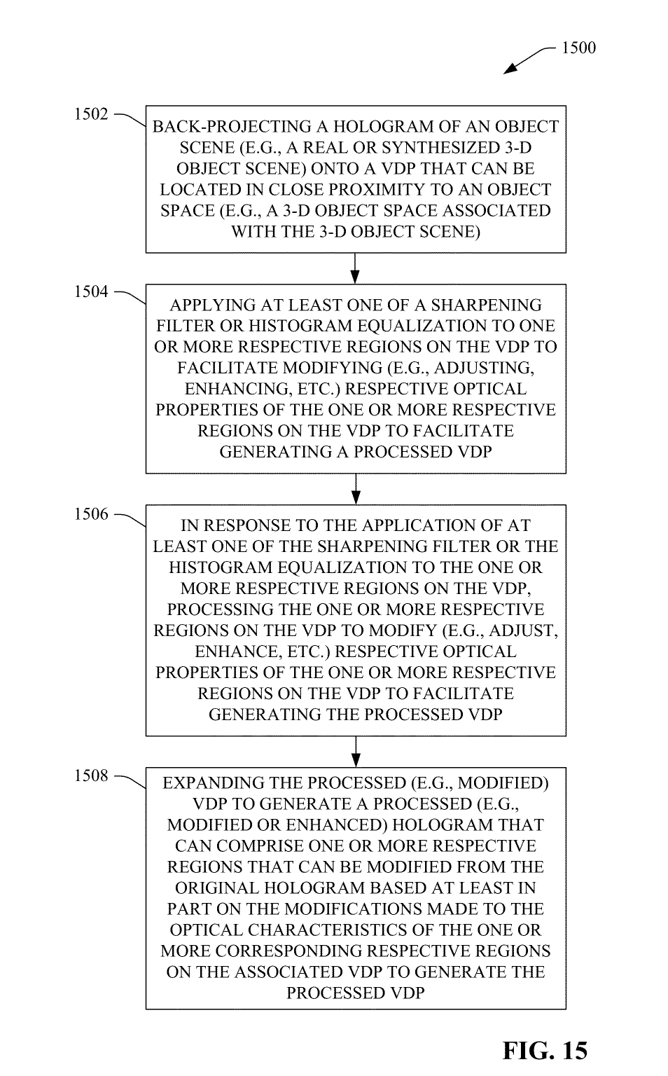

Turning to FIG. 15, depicted is a flow diagram of an example method 1500 that can apply a sharpening filter(s) or histogram equalization to a VDP associated with a hologram to efficiently generate (e.g., in real or at least near real time) a modified (e.g., an enhanced) hologram (e.g., an enhanced full-parallax 3-D Fresnel hologram of a real or synthetic 3-D object scene), in accordance with various embodiments and aspects of the disclosed subject matter. The method 1500 can be implemented by an HGC comprising a hologram enhancer component.

At 1502, a hologram of an object scene (e.g., a real or synthesized 3-D object scene) can be back-projected onto a VDP that can be located in close proximity to (e.g., within a defined distance of) an object space (e.g., a 3-D object space associated with the 3-D object scene). The hologram enhancer component can back-project the hologram onto the VDP, which can be located within a desired defined (e.g., close) distance of the object space.

At 1504, at least one of a sharpening filter or histogram equalization can be applied to one or more respective regions on the VDP to facilitate modifying (e.g., adjusting, enhancing, etc.) respective optical properties of the one or more respective regions on the VDP to facilitate generating a processed VDP. The hologram enhancer component can apply at least one of the sharpening filter(s) or histogram equalization to the one or more respective regions on the VDP to facilitate modifying the respective optical properties of the one or more respective regions on the VDP to facilitate generating the processed VDP.

At 1506, in response to the application of at least one of the sharpening filter or the histogram equalization to the one or more respective regions on the VDP, the one or more respective regions on the VDP can be respectively processed to modify (e.g., adjust, enhance, etc.) respective optical properties of the one or more respective regions on the VDP to facilitate generating the processed VDP. By applying at least one of the sharpening filter or the histogram equalization to the one or more respective regions on the VDP, the hologram enhancer component can process the one or more respective regions on the VDP to modify (e.g., adjust, enhance, etc.) optical (e.g., visual) characteristics (e.g., sharpness, contrast, brightness, etc.) of the one or more respective regions on the VDP to facilitate making corresponding modifications to the optical characteristics (e.g., sharpness, contrast, brightness, etc.) of one or more respective corresponding regions on the hologram to facilitate generating a processed (e.g., modified or enhanced) hologram.

At 1508, the processed (e.g., modified) VDP can be expanded to generate a processed (e.g., modified or enhanced) hologram that can comprise one or more respective regions that can be modified from the original hologram based at least in part on the modifications made to the optical characteristics (e.g., sharpness, contrast, brightness, etc.) of the one or more corresponding respective regions on the associated VDP to generate the processed VDP. The hologram enhancer component can expand the processed VDP to generate the processed hologram that can represent the object scene (e.g., to more closely represent the original 3-D object scene, or to modify certain optical characteristics of one or more corresponding regions of the hologram of the original 3-D object scene, or a combination thereof). For example, the hologram enhancer component can expand the processed VDP to generate the processed hologram using the techniques, algorithms, equations, etc., as more fully disclosed herein, wherein the processed hologram can comprise one or more respective regions that can be modified from the original hologram based at least in part on the modifications made to the optical characteristics (e.g., sharpness, contrast, brightness, etc.) of the one or more corresponding respective regions on the associated VDP to generate the processed VDP. A display component (e.g., LCOS display device(s)) can present holographic images (e.g., modified or enhanced full-parallax 3-D Fresnel holographic images) that can represent the object scene based at least in part on the processed (e.g., modified or enhanced) hologram (e.g., full-parallax 3-D Fresnel hologram).

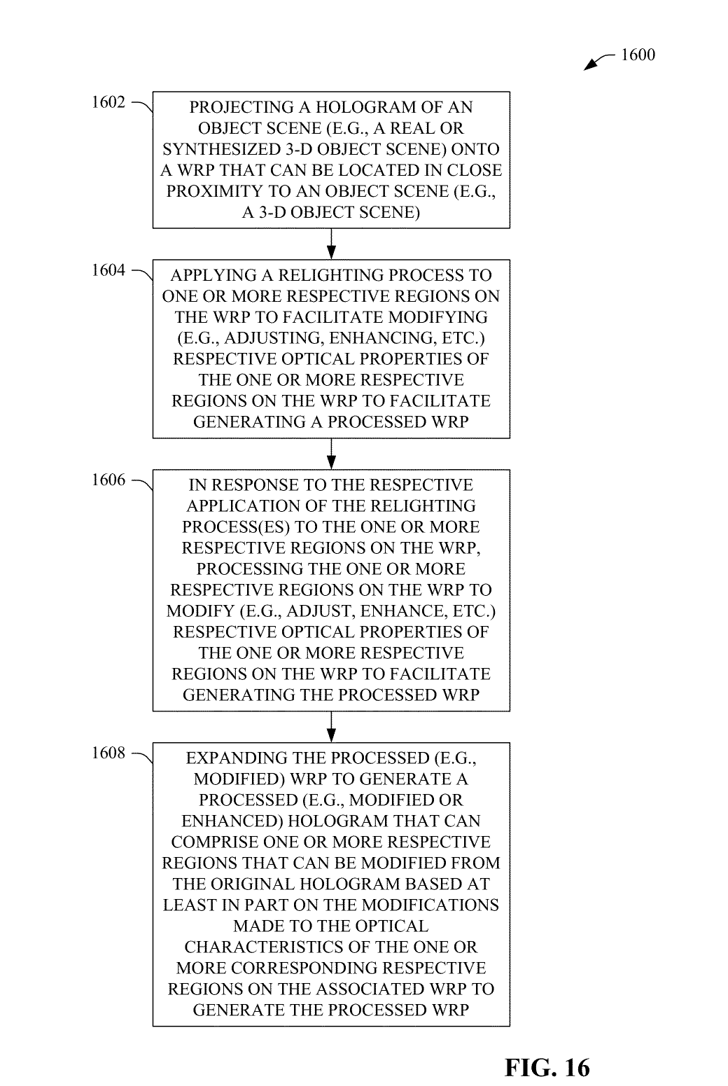

FIG. 16 presents a flow diagram of an example method 1600 for relighting a hologram to facilitate generating (e.g., in real or at least near real time) an enhanced (e.g., desirably relit) hologram (e.g., an enhanced full-parallax 3-D Fresnel hologram) of a real or synthetic 3-D object scene), in accordance with various embodiments and aspects of the disclosed subject matter.

At 1602, a hologram of an object scene (e.g., a real or synthesized 3-D object scene) can be projected (e.g., projected or back-projected) onto a WRP (e.g., a VDP) that can be located in close proximity to (e.g., within a defined distance of) an object scene (e.g., a 3-D object scene). The hologram enhancer component can project the hologram onto the WRP, which can be located within a desired defined (e.g., close) distance of the object space.

At 1604, a relighting process can be respectively applied to one or more respective regions on the WRP to facilitate modifying (e.g., adjusting, enhancing, etc.) respective optical properties of the one or more respective regions on the WRP to facilitate generating a processed WRP. The hologram enhancer component can apply the relighting process or respective relighting processes to the one or more respective regions on the WRP to facilitate modifying the respective optical properties of the one or more respective regions on the WRP to facilitate generating the processed WRP.

At 1606, in response to the respective application of the relighting process(es) to the one or more respective regions on the WRP, the one or more respective regions on the WRP can be respectively processed to modify (e.g., adjust, enhance, etc.) respective optical properties of the one or more respective regions on the WRP to facilitate generating the processed WRP. By applying the relighting process(es) to the one or more respective regions on the WRP, the hologram enhancer component can process the one or more respective regions on the WRP to modify (e.g., adjust, enhance, etc.) optical (e.g., visual) characteristics (e.g., illumination, depth, etc.) of the one or more respective regions on the WRP to facilitate making corresponding modifications to the optical characteristics (e.g., illumination, depth, etc.) of one or more respective corresponding regions on the hologram to facilitate generating a processed (e.g., enhanced) hologram.

At 1608, the processed (e.g., modified) WRP can be expanded to generate a processed (e.g., modified or enhanced) hologram that can comprise one or more respective regions that can be modified from the original hologram based at least in part on the modifications made to the optical characteristics (e.g., illumination, depth, etc.) of the one or more corresponding respective regions on the associated WRP to generate the processed WRP. The hologram enhancer component can expand the processed WRP to generate the processed hologram that can represent the object scene (e.g., to more closely represent the original 3-D object scene, or to modify certain optical characteristics of one or more corresponding regions of the hologram of the original 3-D object scene, or a combination thereof). For example, the hologram enhancer component can expand the processed WRP to generate the processed hologram using the techniques, algorithms, equations, etc., as more fully disclosed herein, wherein the processed hologram can comprise one or more respective regions that can be modified from the original hologram based at least in part on the modifications made to the optical characteristics (e.g., illumination, depth, etc.) of the one or more corresponding respective regions on the associated WRP to generate the processed WRP. A display component (e.g., LCOS display device(s)) can present holographic images (e.g., modified or enhanced full-parallax 3-D Fresnel holographic images) that can represent the object scene based at least in part on the processed (e.g., modified or enhanced) hologram (e.g., full-parallax 3-D Fresnel hologram).

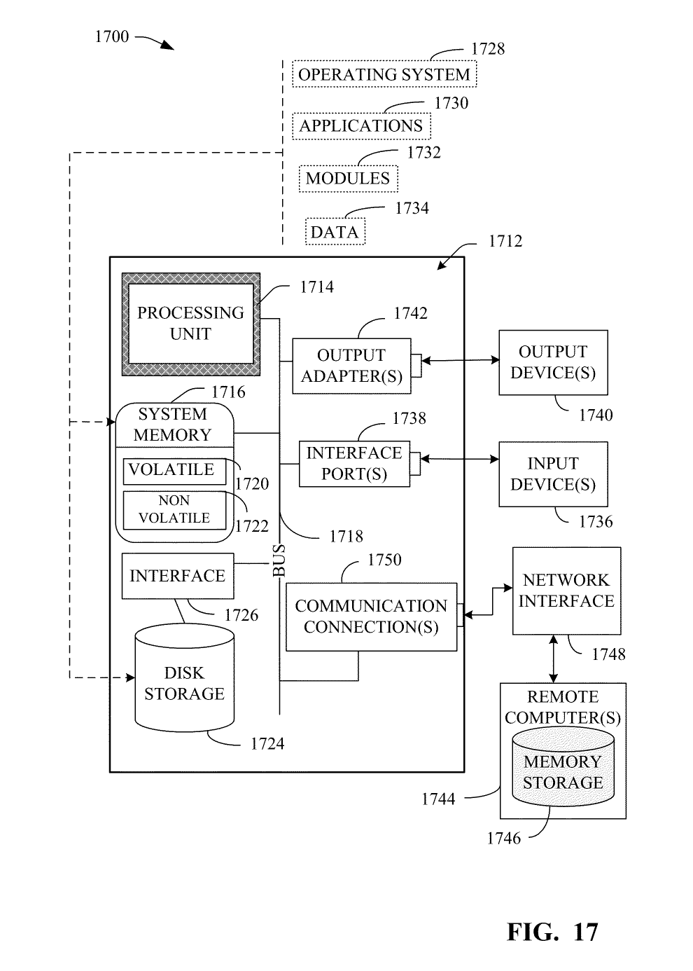

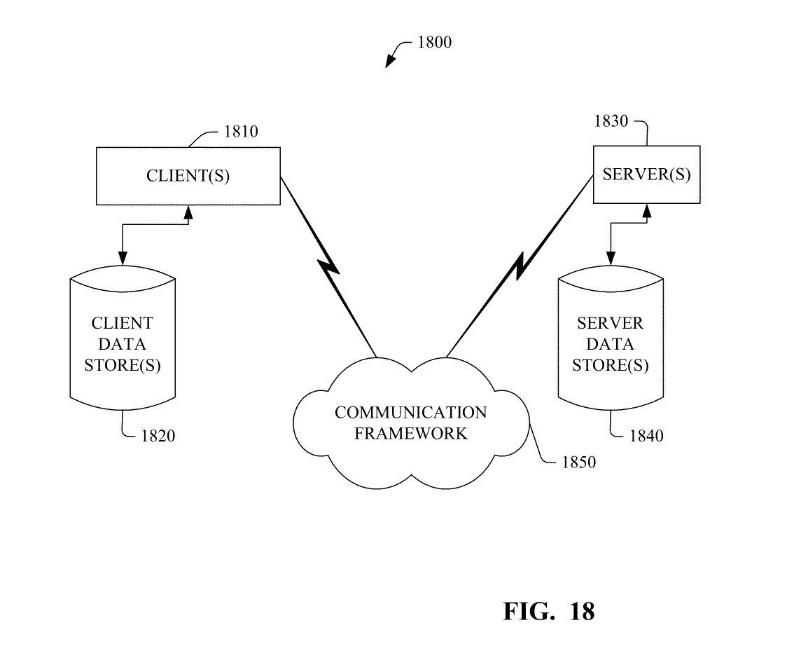

In order to provide a context for the various aspects of the disclosed subject matter, FIGS. 17 and 18 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject disclosure also may be implemented in combination with other program modules. Generally, program modules include routines, programs, components, data structures, etc. that perform particular tasks and/or implement particular abstract data types. Moreover, those skilled in the art will appreciate that the methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the subject disclosure can be practiced on stand-alone computers. In a distributed computing environment, program modules may be located in both local and remote memory storage devices.

With reference to FIG. 17, a suitable environment 1700 for implementing various aspects of the claimed subject matter includes a computer 1712. The computer 1712 includes a processing unit 1714, a system memory 1716, and a system bus 1718. It is to be appreciated that the computer 1712 can be used in connection with implementing one or more of the systems or components (e.g., HGC, hologram enhancer component, display component, etc.) shown and/or described in connection with, for example, FIGS. 1-16. The system bus 1718 couples system components including, but not limited to, the system memory 1716 to the processing unit 1714. The processing unit 1714 can be any of various available processors. Dual microprocessors and other multiprocessor architectures also can be employed as the processing unit 1714.

The system bus 1718 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1716 includes volatile memory 1720 and nonvolatile memory 1722. The basic input/output system (BIOS), containing the basic routines to transfer information between elements within the computer 1712, such as during start-up, is stored in nonvolatile memory 1722. By way of illustration, and not limitation, nonvolatile memory 1722 can include read only memory (ROM), programmable ROM (PROM), electrically programmable ROM (EPROM), electrically erasable programmable ROM (EEPROM), or flash memory. Volatile memory 1720 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1712 also can include removable/non-removable, volatile/non-volatile computer storage media. FIG. 17 illustrates, for example, a disk storage 1724. Disk storage 1724 includes, but is not limited to, devices like a magnetic disk drive, floppy disk drive, tape drive, Jaz drive, Zip drive, LS-100 drive, flash memory card, or memory stick. In addition, disk storage 1724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1724 to the system bus 1718, a removable or non-removable interface is typically used, such as interface 1726).

It is to be appreciated that FIG. 17 describes software that acts as an intermediary between users and the basic computer resources described in the suitable operating environment 1700. Such software includes an operating system 1728. Operating system 1728, which can be stored on disk storage 1724, acts to control and allocate resources of the computer system 1712. System applications 1730 take advantage of the management of resources by operating system 1728 through program modules 1732 and program data 1734 stored either in system memory 1716 or on disk storage 1724. It is to be appreciated that the claimed subject matter can be implemented with various operating systems or combinations of operating systems.

A user enters commands or information into the computer 1712 through input device(s) 1736. Input devices 1736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1714 through the system bus 1718 via interface port(s) 1738. Interface port(s) 1738 include, for example, a serial port, a parallel port, a game port, and a universal serial bus (USB). Output device(s) 1740 use some of the same type of ports as input device(s) 1736. Thus, for example, a USB port may be used to provide input to computer 1712, and to output information from computer 1712 to an output device 1740. Output adapter 1742 is provided to illustrate that there are some output devices 1740 like monitors, speakers, and printers, among other output devices 1740, which require special adapters. The output adapters 1742 include, by way of illustration and not limitation, video and sound cards that provide a means of connection between the output device 1740 and the system bus 1718. It should be noted that other devices and/or systems of devices provide both input and output capabilities such as remote computer(s) 1744.

Computer 1712 can operate in a networked environment using logical connections to one or more remote computers, such as remote computer(s) 1744. The remote computer(s) 1744 can be a personal computer, a server, a router, a network PC, a workstation, a microprocessor based appliance, a peer device or other common network node and the like, and typically includes many or all of the elements described relative to computer 1712. For purposes of brevity, only a memory storage device 1746 is illustrated with remote computer(s) 1744. Remote computer(s) 1744 is logically connected to computer 1712 through a network interface 1748 and then physically connected via communication connection 1750. Network interface 1748 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1750 refers to the hardware/software employed to connect the network interface 1748 to the bus 1718. While communication connection 1750 is shown for illustrative clarity inside computer 1712, it can also be external to computer 1712. The hardware/software necessary for connection to the network interface 1748 includes, for exemplary purposes only, internal and external technologies such as, modems including regular telephone grade modems, cable modems and DSL modems, ISDN adapters, and Ethernet cards.

FIG. 18 is a schematic block diagram of a sample-computing environment 1800 with which the subject disclosure can interact. The system 1800 includes one or more client(s) 1810. The client(s) 1810 can be hardware and/or software (e.g., threads, processes, computing devices). The system 1800 also includes one or more server(s) 1830. Thus, system 1800 can correspond to a two-tier client server model or a multi-tier model (e.g., client, middle tier server, data server), amongst other models. The server(s) 1830 can also be hardware and/or software (e.g., threads, processes, computing devices). The servers 1830 can house threads to perform transformations by employing the subject disclosure, for example. One possible communication between a client 1810 and a server 1830 may be in the form of a data packet transmitted between two or more computer processes.

The system 1800 includes a communication framework 1850 that can be employed to facilitate communications between the client(s) 1810 and the server(s) 1830. The client(s) 1810 are operatively connected to one or more client data store(s) 1820 that can be employed to store information local to the client(s) 1810. Similarly, the server(s) 1830 are operatively connected to one or more server data store(s) 1840 that can be employed to store information local to the servers 1830.

It is to be appreciated and understood that components (e.g., holographic generator component, hologram enhancer component, expander component, processor component, look-up table, data store, display component, etc.), as described with regard to a particular system or method, can include the same or similar functionality as respective components (e.g., respectively named components or similarly named components) as described with regard to other systems or methods disclosed herein.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As utilized herein, terms “component,” “system,” and the like, can refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein can encompass a computer program accessible from any computer-readable device, carrier, or media. For example, computer readable media can include, but is not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a graphics processing unit (GPU), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM)). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

What has been described above includes examples of aspects of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system, comprising:
at least one memory that stores computer executable components; and
at least one processor that facilitates execution of the computer executable components stored in the at least one memory, the computer executable components, comprising:
a hologram enhancer component that projects a hologram on a virtual diffraction plane that is within a defined distance of an object space associated with an object scene represented by the hologram, processes one or more optical properties of one or more respective regions on the virtual diffraction plane to facilitate modification of the one or more optical characteristics of the one or more respective regions on the virtual diffraction plane to generate a processed virtual diffraction plane that facilitates generation of a processed hologram that represents the object scene; and
a display component that presents one or more holographic images associated with the processed hologram.

2. The system of claim 1, wherein the hologram enhancer component expands the processed virtual diffraction plane to generate the processed hologram that facilitates the presentation of the one or more holographic images.

3. The system of claim 2, wherein the hologram enhancer component comprises at least one of a graphic processing unit or a field-programmable gate array that facilitates performance of one or more operations relating to at least one of the modification of the one or more optical characteristics of the one or more respective regions on the virtual diffraction plane to generate the processed virtual diffraction plane, or the expansion of the processed virtual diffraction plane to generate the processed hologram.

4. The system of claim 1, wherein the hologram enhancer component expands the processed virtual diffraction plane to generate the processed hologram in part by conversion of the processed virtual diffraction plane to the processed hologram in a frequency space to facilitate reducing computation time associated with the expansion of the processed virtual diffraction plane to generate the processed hologram.

5. The system of claim 1, wherein the one or more respective regions on the virtual diffraction plane respectively correspond to one or more respective areas of the object scene.

6. The system of claim 1, wherein the processing of the one or more optical properties of the one or more respective regions on the virtual diffraction plane to facilitate the modification of the one or more optical characteristics of the one or more respective regions on the virtual diffraction plane facilitates modification of one or more optical characteristics of one or more respective regions on the processed hologram that correspond to the one or more respective regions on the virtual diffraction plane.

7. The system of claim 1, wherein the projection of the hologram on the virtual diffraction plane comprises back-projection of the hologram on the virtual diffraction plane.

8. The system of claim 1, wherein the hologram enhancer component applies one or more sharpening filters to a region of the one or more respective regions on the virtual diffraction plane to modify the one or more optical characteristics of the region to facilitate sharpening a portion of a holographic image associated with a region of the one or more respective regions on the processed hologram that corresponds to the region on the virtual diffraction plane.

9. The system of claim 1, wherein the hologram enhancer component applies histogram equalization to a region of the one or more respective regions on the virtual diffraction plane to modify the one or more optical characteristics of the region to facilitate modification of contrast of a portion of a holographic image associated with a region of the one or more respective regions on the processed hologram that corresponds to the region on the virtual diffraction plane.

10. The system of claim 1, wherein the virtual diffraction plane comprises a virtual wavefront recording plane, and the hologram enhancer component applies a relighting process to a region of the one or more respective regions on the virtual wavefront recording plane to modify the one or more optical characteristics of the region to facilitate relighting a portion of a holographic image associated with a region of the one or more respective regions on the processed hologram that corresponds to the region on the virtual wavefront recording plane.

11. The system of claim 1, further comprising a display component that includes one or more display units that generate and display the one or more holographic images based at least in part on the processed hologram.

12. The system of claim 11, wherein a display unit of the one or more display units is a liquid crystal display device or a liquid crystal on silicon display device.

13. The system of claim 1, wherein the object scene is a real or synthesized three-dimensional object scene, the processed hologram is a processed full-parallax three-dimensional hologram that represents the real or synthesized three-dimensional object scene, and the one or more holographic images are one or more three-dimensional full-parallax holographic images.

14. A method, comprising:
projecting, by a system comprising a processor, a hologram on a virtual diffraction plane that is within a defined distance of an object space associated with an object scene represented by the hologram; and
processing, by the system, one or more optical properties of one or more respective regions on the virtual diffraction plane to facilitate modifying one or more optical characteristics of the one or more respective regions on the virtual diffraction plane to facilitate generating a processed virtual diffraction plane that facilitates generating a processed hologram that represents the object scene.

15. The method of claim 14, further comprising:
converting, by the system, the processed virtual diffraction plane to the processed hologram that represents the object scene; and
displaying, by the system, one or more holographic images associated with the processed hologram.

16. The method of claim 14, wherein the projecting the hologram further comprises back-projecting the hologram on the virtual diffraction plane.

17. The method of claim 14, wherein the one or more respective regions on the virtual diffraction plane respectively correspond to one or more respective areas of the object scene.

18. The method of claim 14, further comprising:
modifying the one or more optical characteristics of the one or more respective regions on the virtual diffraction plane to facilitate modifying one or more optical characteristics of one or more respective regions on the processed hologram that correspond to the one or more respective regions on the virtual diffraction plane.

19. The method of claim 14, further comprising:
applying, by the system, a sharpening filter to a region of the one or more respective regions on the virtual diffraction plane to facilitate modifying the one or more optical characteristics of the region to facilitate sharpening a portion of a holographic image associated with a region of the one or more respective regions on the processed hologram that corresponds to the region on the virtual diffraction plane.

20. The method of claim 14, further comprising:
applying, by the system, histogram equalization to a region of the one or more respective regions on the virtual diffraction plane to facilitate modifying the one or more optical characteristics of the region to facilitate modifying contrast of a portion of a holographic image associated with a region of the one or more respective regions on the processed hologram that corresponds to the region on the virtual diffraction plane.

21. The method of claim 14, further comprising:
applying, by the system, a relighting process to a region of the one or more respective regions on the virtual diffraction plane to facilitate modifying the one or more optical characteristics of the region to facilitate relighting a portion of a holographic image associated with a region of the one or more respective regions on the processed hologram that corresponds to the region on the virtual diffraction plane.

22. The method of claim 14, wherein the object scene is a real or synthesized three-dimensional object scene, the processed hologram is a processed full-parallax three-dimensional hologram that represents the real or synthesized three-dimensional object scene, and the one or more holographic images are one or more three-dimensional full-parallax holographic images.

23. A computer readable storage medium comprising computer executable instructions that, in response to execution, cause a system comprising a processor to perform operations, comprising:
projecting a hologram on a virtual diffraction plane that is within a defined distance of an object space associated with an object scene represented by the hologram; and
modifying one or more optical properties of one or more respective regions on the virtual diffraction plane to facilitate modifying one or more optical characteristics of the one or more respective regions on the virtual diffraction plane to facilitate generating a processed virtual diffraction plane that facilitates generating a processed hologram that represents the object scene.

24. The computer readable storage medium of claim 23, wherein the operations further comprise:
expanding the processed virtual diffraction plane to generate the processed hologram that facilitates displaying one or more holographic images associated with the processed hologram; and
displaying one or more holographic images associated with the processed hologram.

25. A system, comprising:
means for projecting a hologram on a virtual diffraction plane that is within a defined distance of an object space associated with an object scene represented by the hologram; and
means for adjusting one or more optical properties of one or more respective regions on the virtual diffraction plane to facilitate adjusting one or more optical characteristics of the one or more respective regions on the virtual diffraction plane to facilitate generating a processed virtual diffraction plane that facilitates generating a processed hologram that represents the object scene.

26. The system of claim 25, further comprising:
means for converting the processed virtual diffraction plane to facilitate the generating the processed hologram; and
means for displaying one or more holographic images based at least in part on the processed hologram.
